(19) United States
(12) Patent Application Publication
(10) Pub. No.: US 2007/0065639 A1
(43) Pub. Date: Mar. 22, 2007

(54) Circuit board and manufacturing method of the circuit board

(75) Inventors: Atsuko Iida, Yokohama-shi (JP); Koichi Ishii, Kawasaki-shi (JP); Yasushi Shinjiyo, Kawasaki-shi (JP); Takaaki Yasumoto, Kawasaki-shi (JP); Naoko Yanase, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/443,282

(22) Filed: May 31, 2006

(30) Foreign Application Priority Data
Sep. 16, 2005 (JP) P2005-271211

(51) Int. Cl. G11B 5/64

(52) U.S. Cl. 428/141

(57) ABSTRACT

A circuit board includes a substrate, a nonconductive resin layer selectively formed on the substrate and containing fine metal particles, and a conductive metal layer formed on the resin layer, in contact with the fine metal particles which are exposed from the resin layer. A surface of the resin layer has irregularities, in an interface between the resin layer and the conductive metal layer. In a roughness curve of a section of the resin layer, in a case of an wavelength (λc) at the boundary of a roughness component and a waviness component is 1 μm, a maximum height (Rz) per reference length (1r) of 1 μm is 20 nm to 500 nm.

### CROSS-REFERENCE TO THE INVENTION

This application is based upon and claims the benefit of priority from the prior Japanese Patent Application No. 2005-271211, filed on Sep. 16, 2005; the entire contents 6f which are incorporated herein by reference.

### BACKGROUND OF THE INVENTION

1. Field of the Invention

The present invention relates to a circuit board having fine pitch wiring patterns suitable for being mounted and packaged on a semiconductor element, a chip component and the like, and a manufacturing method of the circuit board.

2. Description of the Related Art

Conventionally, as a method for manufacturing a circuit board, a method using, for example, electrostatic transfer is adopted. In manufacture of circuit boards by using this method, an art of forming a conductor pattern by applying dry-type electrophotographic technology by using a toner to which a catalyst material active in an electroless plating bath is added is disclosed (see JP-A 58-57783 (KOKAI)).

In this method for manufacturing a circuit board which applies the dry-type electrophotographic technology, an entire surface of a photoconductive layer is electrostatically charged first by a corona discharge by an electrifier, then, a conductor pattern is imaged on the surface of the photoconductive layer by using an optical system, and an electrostatic latent image corresponding to the conductor pattern is formed. Then, the electrostatic latent image is caused to adsorb fine powder to which the catalyst material active in an electroless plating bath adheres, as a developer, and a developer pattern is formed on the surface of the photoconductive layer of a photoconductor drum. Further, an electric field to make a base material side positive is applied to the photoconductor drum, the developer pattern is transferred onto the base material, and this base material is put into an electroless copper plating basin, and copper plating of a predetermined thickness is applied on the developer pattern in the copper electroless plating bath to form a conductor pattern. In this case, as the developer, the one with fine iron particles of a particle size of several μm adhering to fine resin powder, which has a particle size of 10 to 20 μm is used.

As a method for manufacturing a circuit board, an art of forming an electronic circuit on a substrate by using metal-containing resin particles containing conductive fine metal particles and electrophotographic technology is disclosed (see US-2004/0197487-A1, JP-A 2004-48030 (KOKAI), and JP-A 2005-50992 (KOKAI)). An art of coating an electric conducting agent by an inkjet method or the like, forming a lower conductor pattern by heating at 100 to 500° C., and forming an upper conductor pattern on the lower conductor pattern by plating is disclosed (see JP-A 2005-50965 (KOKAI)).

Further, in order to miniaturize wiring width in a circuit board, an art of reducing the particle size of a developer used for dry-type electrophotographic method is disclosed (see Naoko Yamaguchi, et al. Japan Hardcopy 2004 Journal, p. 121, 2004). The developer used here is made by causing fine needle-shaped copper particles of a length of about 1 μm to adhere to fine resin powder of a particle size of about 5 to 10 μm. In this art, it is possible to miniaturize the pattern width in the circuit board to about 80 μm. In the method for manufacturing a circuit board with application of the conventional dry-type electrophotographic technology, the particle size of the developer which is used is 10 to 20 μm, and therefore, the pattern width formed by the developer is limited, which causes the problem of being incapable of responding to the demand of miniaturization of circuit boards in recent years. In addition, the particle size of fine iron particles used as the active catalyst in an electroless plating bath is several μm and comparatively large, and therefore, adhesion of a plating deposition film formed on a developer pattern with the developer pattern is low, whereby favorable mechanical characteristics sometimes cannot be obtained.

The width of a pattern which is formed by using the conventional dry-type electrophotographic method which is designed to reduce the particle size of a developer can be miniaturized to about 80 μm, but with the demand for further miniaturization of the pattern width, enhancement of adhesion of a plating deposition film formed on a developer pattern and the developer pattern is demanded in recent years, and there arises the problem of being incapable of respond to the demand with the hitherto used technique.

### BRIEF SUMMARY OF THE INVENTION

It is an object of the present invention to provide a circuit board with a fine pitch pattern formed with high precision, excellent in adhesion of a plating deposition film and a base pattern, and including mechanical strength that withstands practical use, and a manufacturing method of the circuit board.

According to an aspect of the present invention, a circuit board including a substrate, a resin layer selectively formed on the aforesaid substrate and containing fine metal particles, and a conductive metal layer formed on the aforesaid resin layer, in contact with the aforesaid fine metal particles which are exposed from the aforesaid resin layer, wherein in irregularities of the aforesaid resin layer in an interface of the aforesaid resin layer and the aforesaid conductive metal layer, a maximum height (Rz) per reference length (1r=λc) is 20 nm≦Rz≦500 nm when a wavelength at a boundary of a roughness component and a waviness component is set as λc in a roughness curve of a section of the aforesaid resin layer, is provided.

Further, according to an aspect of the present invention, a circuit board including a substrate, a resin layer selectively formed on the aforesaid substrate and containing fine metal particles, and a conductive metal layer formed on the aforesaid resin layer, in contact with the aforesaid fine metal particles which are exposed from the aforesaid resin layer, wherein in irregularities of the aforesaid resin layer in an interface of the aforesaid resin layer and the aforesaid conductive metal layer, a maximum height (Rz) per reference length (1r=λc) is 20 nm≦Rz≦1 μm when a wavelength at a boundary of a roughness component and a waviness component is set as λc in a roughness curve of a section of the aforesaid resin layer, is provided.

Further, according to an aspect of the present invention, a manufacturing method of a circuit board including forming an electrostatic latent image of a predetermined pattern on a photoreceptor, causing an electric insulating solvent, in which resin particles having fine metal particles are dispersed, to adhere onto the photoreceptor on which the electrostatic latent image is formed to form a visible image, drying the solvent adhering onto the photoreceptor, forming a resin layer on a base material by transferring the dried visible image onto the base material, performing surface treatment for a surface of the resin layer formed on the base material by plasma to form a surface with irregularities on the surface, and forming a conductive metal layer in contact with the fine metal particles exposed from the resin layer, on the resin layer subjected to the aforesaid surface treatment, is provided.

Further, according to an aspect of the present invention, a manufacturing method of a circuit board, including forming an electrostatic latent image of a predetermined pattern on a photoreceptor, causing resin particles having fine metal particles to adhere onto the photoreceptor on which the electrostatic latent image is formed to form a visible image, forming a resin layer on a base material by transferring the resin particles constituting the visible image onto the base material, performing surface treatment for a surface of the resin layer formed on the base material by plasma to form a surface with irregularities on the surface, and forming a conductive metal layer in contact with the fine metal particles exposed from the resin layer, on the resin layer subjected to the aforesaid surface treatment, is provided.

### BRIEF DESCRIPTION OF THE DRAWINGS

Though the present invention is described with reference to the drawings, the drawings are to be regarded as only illustrative and not as restrictive in any way.

FIG. 1 is a view schematically showing a section of a circuit board of a first embodiment of the present invention.

FIG. 2 is a view schematically showing a section of an interface of a resin layer and a conductive metal layer in the circuit board of the first embodiment of the present invention under magnification.

FIG. 3 is a view schematically showing an entire manufacturing apparatus of the circuit board of the first embodiment of the present invention.

FIG. 4 is a view schematically showing a pattern forming apparatus.

FIG. 5 is a plane view showing a metal dispersed resin particle with fine metal particles adhering to a resin particle surface.

FIG. 6 is a view schematically showing a section of a circuit board of a second embodiment of the present invention.

FIG. 7 is a view schematically showing a section of an interface of a resin layer and a conductive metal layer in the circuit board of the second embodiment of the present invention under magnification.

FIG. 8 is a view schematically showing an entire manufacturing apparatus of the circuit board of the second embodiment of the present invention.

FIG. 9 is a view schematically showing a pattern forming apparatus.

FIG. 10 is a plane view showing a metal dispersed resin particle with fine metal particles adhering to a resin particle surface.

FIG. 11 is a view schematically showing a section of a multilayer circuit board.

FIG. 12A-FIG. 12G are a view schematically showing a section in one forming step of the multilayer circuit board.

FIG. 13 is a view schematically showing a section of a resin layer on the occasion of performing surface roughening by a chemical solution under magnification.

### DETAILED DESCRIPTION OF THE INVENTION

Hereinafter, one embodiment of the present invention will be described with reference to the drawings.

### First Embodiment

In a first embodiment, the case where a conductor pattern is formed by using a wet type developing device will be described.

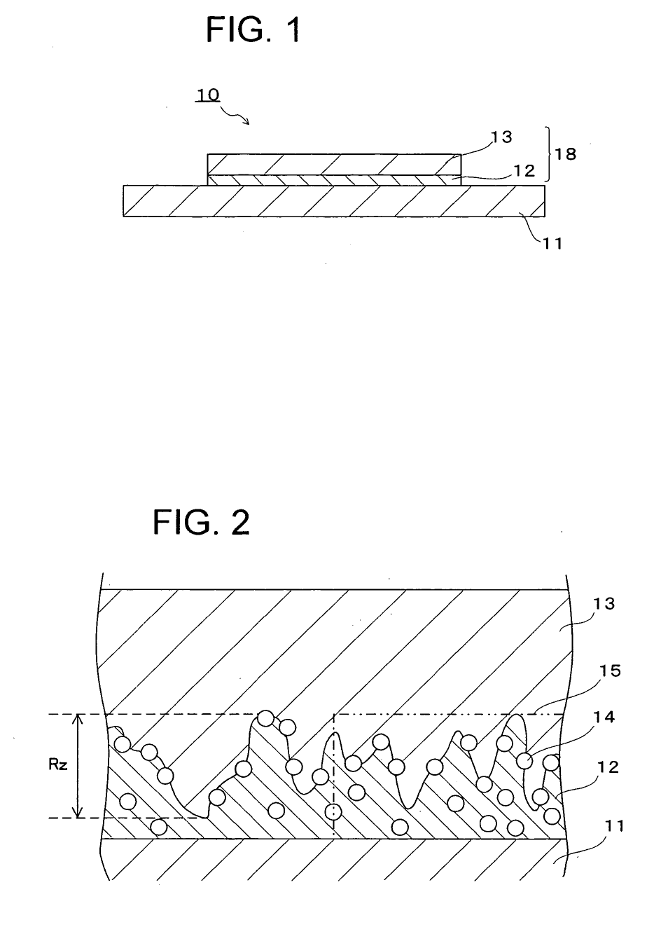

FIG. 1 schematically shows a section of a circuit board 10 of the first embodiment of the present invention. FIG. 2 schematically shows a section of an interface of a resin layer 12 and a conductive metal layer 13 under magnification.

As shown in FIGS. 1 and 2, the circuit board 10 is constructed by a substrate 11, the nonconductive resin layer 12 which is selectively formed on the substrate 11 and contains fine metal particles 14, and a conductive metal layer 13 which is formed in contact with the fine metal particles 14 exposed from the resin layer 12, on the resin layer 12. A conductor pattern 18 is formed by the resin layer 12 that is a base pattern, and the conductive metal layer 13 that is a plating deposition film.

In this case, the substrate 11 is composed of a nonconductive material, and is specifically composed of, for example, a polyimide resin, a silicon resin, an epoxy resin, a PET (Polyethylene Telephthalate) resin, an urethane resin, a polycarbonate resin, a polyimide resin, a PPE (Polyphenylene Ethylene) resin, a PEN (Polyethylene Naphthalete) resin, a glass epoxy material with glass fiber dispersed therein, glass, a silicon wafer or the like, or a material with any one of them used as a main component.

The resin which forms the resin layer 12 is composed of, for example, a thermoplastic resin or the like, and specifically, materials such as an acrylic resin, a styrene-acryl resin, a polystyrene resin, a melamine resin, an urethane resin, a polyphenylene sulfide resin, a polyethylene telephthalate resin, a polyethylene resin, a polypropylene resin, a vinyl nitride resin, and a polycarbonate resin can be cited. The resin which forms the resin layer 12 may be composed of, for example, a thermosetting resin or the like, and specifically, materials such as an epoxy resin, a polyimide resin, a phenol resin, a bismaleimide resin, a cyanate ester resin, a bismaleimide-triazine resin, a benzocyclobuten resin, a polyimide resin, a polybenzooxazole resin, a butadiene resin, a silicon resin, a polycarbodiimide resin, and a polyurethane resin can be cited. In the thermosetting resin, a thermosetting resin of a B stage which is solid at a room temperature may be used. In this case, the B stage means a half-cured state in which at least a part of the thermosetting resin is not cured. Furthermore, the mixed resins of thermoplastic resin and thermosetting resin can be also used. A charge control agent may be added to the resin which forms the resin layer 12 as necessary.

The fine metal particle 14 is composed of a conductive material having a catalytic action to the proceeding of a plating reaction, as a plating nucleus on the occasion of forming the conductive metal layer 13 on the resin layer 12. As the material which composes the fine metal particle 14, palladium, white gold, gold, silver, cobalt, nickel, copper and the like can be specifically cited. Further, the fine metal particle 14 may be composed of a material such as a metal oxide, a metal nitride, a metal silicide, a metal carbide, or a conductive polymer, which have conductivity.

For example, when palladium is used as a plating catalyst, the fine metal particles 14 may be composed of fine particles of palladium, but other than this, for example, after fine particles composed of carbon nanotube are immersed in a solution of tin chloride, the fine particles composed of carbon nanotube may be immersed in a palladium chloride solution and may be stirred, and dried to form the fine metal particles 14 having a palladium layer on their surfaces. The fine metal particles 14 may be formed by coating palladium metal on the surfaces of the fine particles composed of carbon nanotube by sputtering. Further, the palladium metal and fine particles are mechanically and forcefully stirred, and palladium is coated on the surfaces of fine particles composed of carbon nanotube to form the fine metal particles 14.

The particle size of the fine metal particle 14 is 5 nm to 100 nm. The particle size of the fine metal particle 14 is set in this range because when the particle size is smaller than 5 nm, the adhesive force to the surface of the resin particle 16 becomes weak, and when the particle size is larger than 100 nm, the development characteristics of a metal dispersed resin particle 17 degrade. A more preferable range of the particle size is 10 nm to 80 nm.

As shown in FIG. 2, in the interface between the resin layer 12 and the conductive metal layer 13, the surface of the resin layer 12 has irregularities as a result of the surface treatment being applied thereto. These irregularities are defined based on the standards of JIS B 0601 (2001), and in the roughness curve of the section of the resin layer 12, in the case of the wavelength (λc) at the boundary of the roughness component and the waviness component is 1 μm, the maximum height (Rz) per reference length (1r) of 1 μm is 20 nm to 500 nm. Here, the maximum height (Rz) is the sum of the maximum value of the crest height and the maximum value of the trough depth in the reference length (1r) of 1 μm. The roughness component is what is obtained by removing the wavelength components which are longer than the waviness component from the components of the sectional curve in the section. Here, even with the wavelength (λs) at the boundary of the roughness component and the wavelength components which are shorter than the roughness component taken into consideration, the range of the maximum height (Rz) does not change. In the roughness curve where the wavelength region is taken in the horizontal axis and the amplitude transmissibility (%) is taken in the vertical axis, λs and λc are defined such that the wavelength corresponding to the amplitude transmissibility of 50% at the short wave side is λs, and the wavelength corresponding to the amplitude transmissibility of 50% at the long wave side is λc (described in paragraph 3. 1. 1. 1 of JIS B 0601 (2001)). Measurement of the irregularities in the section is performed by using, for example, a scanning electron microscope SEM, an atomic force microscopy AFM which detects roughness information of a surface by using a microscopic needle, and an optical microscope which measures surface roughness by utilizing an optical phase difference by irradiating laser light. In the roughness curve obtained by these measurements, the maximum height (Rz) can be analytically obtained by image processing.

The range of the maximum height (Rz) is set at 20 nm to 500 nm here because when the maximum height is smaller than 20 nm, selective removal of the resin is insufficient on the occasion of performing surface treatment, and exposure of the fine metal particles 14 decreases, thus making it impossible to obtain the conductive metal layer 13 that is a favorable plating deposition film. When the maximum height is larger than 500 nm, it becomes difficult for the resin to hold the fine metal particles 14 due to selective removal of the resin by the surface treatment, and the favorable conductive metal layer 13 cannot be obtained. A more preferable range of the maximum height (Rz) is 150 nm to 500 nm. By having the maximum height (Rz) in the range of 150 nm to 500 nm, it becomes possible to increase the exposed fine metal particles 14 while leaving the resin to some degree.

In the section of the resin layer 12, the number (N) of fine metal particles 14, which exist in a region 15 in a rectangular shape enclosed by sides of a length of 1 μm in a direction parallel with the surface of the substrate 11 and sides of a length of 300 nm in a direction perpendicular to the surface of the substrate 11 and including the surface of the resin layer 12, and are at least partially in contact with the conductive metal layer 13, is preferably 20 to 500 in the average value in 10 spots. The number in this range is preferable because when the number (N) of fine metal particles 14 is smaller than 20, exposure frequency of the fine metal particles 14 after surface treatment becomes low even if the fine metal particles 14 of several tens nm order (40 nm to 100 nm) are used, and the conductive metal layer 13 of a favorable plating deposition film cannot be obtained. When the number of fine metal particles 14 is larger than 500, the amount of resin included in the resin layer 12 becomes small even if the extremely fine metal particles 14 of several nm order (5 nm to 20 nm) are used, it becomes difficult to hold the fine metal particles 14, and therefore, favorable conductive metal layer 13 cannot be obtained. Further, a preferable range of the number (N) of the fine metal particles 14 at least partially in contact with the conductive metal layer 13 is 80 to 280. As a result of having the fine metal particles 14 ranging in number from 80 to 280, it is possible to simultaneously take advantage of adhering function of the resin while securing a sufficient number of fine metal particles 14, and the favorable conductive metal layer 13 is obtained.

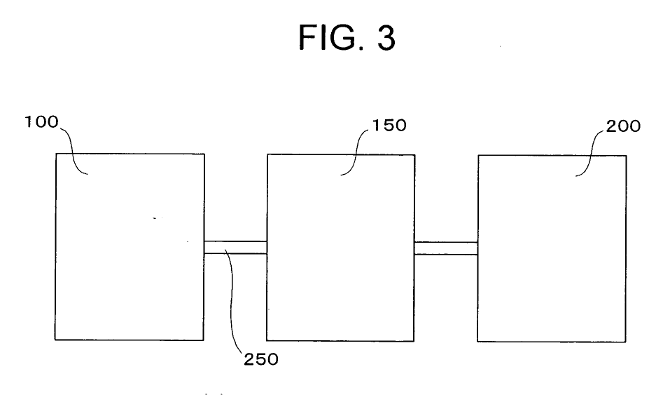

Next, one example of a forming process of the circuit board 10 will be described with reference to FIGS. 3 to 5.

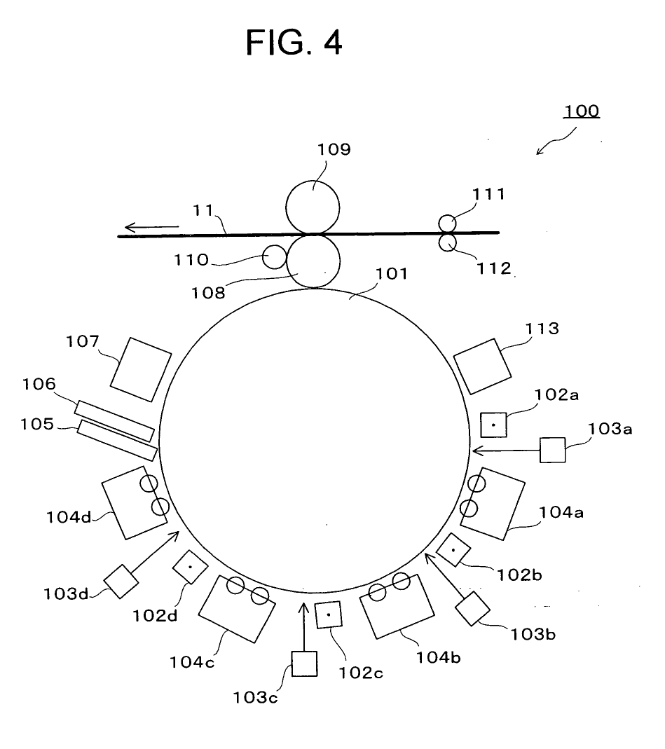

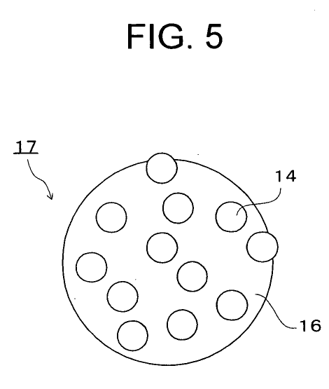

FIG. 3 is a view schematically showing an entire manufacturing apparatus of the circuit board 10 of the first embodiment. FIG. 4 is a view schematically showing a pattern forming apparatus 100. FIG. 5 is a plane view showing a metal dispersed resin particle 17 with the fine metal particles 14 adhering to the surface of the resin particle 16.

As shown in FIG. 3, the manufacturing apparatus of the circuit board 10 is constructed by the pattern forming apparatus 100, a surface treatment apparatus 150, an electroless plating apparatus 200 and carrier means 250, and the circuit board 10 under manufacture is transferred to each of the apparatuses by the transfer means 250.

First, referring to FIG. 4, the pattern forming apparatus 100 will be described.

As shown in FIG. 4, the pattern forming apparatus 100 is mainly constructed by a photoreceptor drum 101, electrifiers 102a, 102b, 102c and 102d, laser exposure devices 103a, 103b, 103c and 103d, developing devices 104a, 104b, 104c and 104d, a liquid removing member 105, a drying mechanism 106, a solvent recovering device 107, an intermediate transfer roller 108, a backup roller 109, an intermediate body cleaning roller 110, a conveyor roller 111, a substrate cleaning roller 112, and a photoreceptor cleaner 113.

Here, a liquid toner that is supplied from the wet type developing devices 104a, 104b, 104c and 104d will be described.

FIG. 5 is a plane view showing the metal dispersed resin particle 17 with the aforementioned fine metal particles 14 adhering to the surface of the resin particle 16.

The liquid toner is made by dispersing the metal dispersed resin particles 17 shown in FIG. 5 in an electrically insulating solvent. The resin particle 16 which constructs the metal dispersed resin particle 17 is formed of the resin forming the aforementioned resin layer 12. The particle size of the resin particle 16 is 0.1 to 1 μm. In this case, the particle size of the resin particle 16 is set in this range because when the particle size is smaller than 0.1 μm, dispersion properties into the electrically insulating solvent degrade, and when the particle size is larger than 1 μm, development characteristics degrade to make it difficult to form fine pitch patterns. A more preferable range of the particle size of the resin particle 16 is 0.1 to 0.6 μm. In this case, the ratio of the fine metal particles 14 dispersing to the surface of the resin particle 16 to the resin particle 16 is 20 to 65 weight %. The ratio of the fine metal particles 14 is set in this range because when the ratio is lower than 20 weight %, distribution frequency of the fine metal particles 14 included in the resin layer 12 is insufficient, exposure of the fine metal particles 14 is small after surface treatment, and the conductive metal layer 13 that is the favorable plating deposition film cannot be obtained, while when the ratio is higher than 65 weight %, a preferable visible image is not sometimes formed on the occasion of forming the visible image on the photoreceptor drum 101 by the liquid toner.

The solvent is composed of an electrically insulating solution, and as the solvent, branched paraffin solvent mixtures such as Isopar L (trade name) (Isopar L, made by Exxon Corporation), Isopar G (trade name), Isopar H (trade name), Isopar K (trade name), Isopar M (trade name), and Isopar V (trade name) are specifically used. As the solvent, aliphatic hydrocarbon (n-pentane, hexane, heptane and the like), alicyclic hydrocarbon (cyclopentane, cyclohexane and the like), aromatic hydrocarbon (benzine, toluene, xylene and the like), halogenated hydrocarbon solvents (chlorinated alkane, fluorinated alkane, chlorofluorocarbon and the like), silicon oils, and mixtures of them, and the like may be used.

The rate of content of the metal dispersed resin particles 17 in the liquid toner with the metal dispersed resin particles 17 dispersed in the solvent is 1.5 to 40 weight %. In this case, the rate of content is set in this range because when the rate of content of the metal dispersed resin particles 17 is lower than 1.5 weight %, the amount of development becomes small on the occasion of forming a visible image on the photoreceptor drum 101 by the liquid toner to make it impossible to form a favorable visible image, while when the rate of content is higher than 40 weight %, adherence of the metal dispersed resin particles 17 to the non-developed portion is caused to make it impossible to form a favorable visible image, either.

Next, with reference to FIG. 4, a forming process of the conductor pattern 18 by the pattern forming apparatus 100 will be described.

The photoreceptor drum 101 with an organic or amorphous silicon photosensitive layer provided on a conductive base substrate is electrically charged uniformly by the electrifier 102a of corona or scorotron. Thereafter, the photoreceptor drum 101 receives exposure of a laser beam that is image-modulated in the laser exposure device 103a, and an electrostatic latent image is formed on its surface. Thereafter, development of the electrostatic latent image is performed by the developing device 104a that houses the liquid toner, and the developed pattern is formed. As shown in FIG. 4, pattern formation may be performed by including a plurality of electrifiers, laser exposure devices and developing devices, and housing different kinds of liquid toners in the developing devices as necessary.

Subsequently, drying processing by the liquid removing member 105 and the drying mechanism 106 is applied to the developed pattern constituted of the liquid toner adhering to the electrostatic latent image. The liquid removing member 105 has the construction in which a continuous foam of urethane foam is wound around a hollow pipe, and absorbs and removes an excess solvent on the developed pattern by sucking an inside of the hollow pipe and lightly pressing the urethane foam surface to the developed pattern. The drying mechanism 106 blows air at high pressure/in a large amount onto the developed pattern from the slit nozzle, and removes the excess solvent included in the developed pattern. The blown air is recovered by the solvent recovering device 107, and the solvent in the air is removed.

The developed pattern on the photosensitive drum 101 which goes through the drying processing is transferred onto the surface of the intermediate transfer roller 108 by pressure contact of the intermediate transfer roller 108. Subsequently, the developed pattern transferred onto the surface of the intermediate transfer roller 108 is transferred by pressure onto the substrate 11 via the backup roller 109 and the resin layer 12 containing the fine metal particles 14 is formed.

In this case, the intermediate transfer roller 108 is constructed by sticking an elastic film onto the surface of the hollow roller made by SUS, for example. The intermediate transfer roller 108 is slowly rotated so that the rotational speed difference from the photoreceptor drum 101 becomes 3%. The developed pattern transferred to the intermediate transfer roller 108 is offset-transferred onto the substrate 11 which is conveyed by pressing the backup roller 109 with the load of 100 kg, for example. The backup roller 109 is constructed by, for example, a hollow roller made by SUS to include a halogen lamp heater therein. The temperature of the surface of the hollow roller heated by the halogen lamp heater is about 100° C.

After transfer processing, the photosensitive drum 101 passes through the photoreceptor cleaner 113, and thereby, has its surface cleaned and proceeds to the next pattern forming operation. The intermediate transfer roller 108 also has its surface cleaned by the intermediate body cleaning roller 110 after going through transfer processing. The substrate 11 has contaminants and dust on its surface removed by passing between the conveyor roller 111 and the substrate cleaning roller 112 which is disposed to be opposed to it and on which a low adhesive rubber layer is formed, before the substrate 11 is conveyed to the transfer position. Though not shown, processing of preventing contaminants and dust from adhering to the surface may be performed by applying destaticizing process to the surface of the substrate 11 before/after passing through the substrate cleaning roller 112. Though not shown, a heater may be disposed on a conveyance path of the substrate 11, and the substrate 11 may be sufficiently heated in advance to enhance transfer efficiency.

Subsequently, as shown in FIG. 4, the substrate 11 on which the resin layer 12 containing the fine metal particles 14 is formed by the pattern forming apparatus 100 is conveyed to the surface treatment device 150 by the conveyor means 250.

Next, treatment in the surface treatment device 150 will be described.

The surface treatment device 150 performs surface treatment of the resin layer 12 by using plasma. In this case, plasma treatment by the mixture gas of an oxygen gas and fluorine gas is performed. In the case of using the mixture gas, the difference in etching rate between the resin and an inorganic substance is large, and therefore, the advantage of being capable of selectively removing the resin by etching from the mixture coating film in which the resin and inorganic substance mixedly exist in the same plane as the resin layer 12 of this embodiment, is provided. Thereby, the region of the resin is selectively removed by etching as shown in FIG. 2, and the surface with irregularities can be formed.

In this case, changing the mixture ratio of an oxygen gas and a fluorine gas facilitates the control of the etching rate of the resin, and is effective for control of a desirable residual amount of the resin in the resin layer 12. In addition to this, it is possible to control the etching rate by controlling back pressure inside the treatment tank, and the full flow of the gas which is one of the factors that determine the back pressure. Further, by changing the mixture ratio of the oxygen gas and fluorine gas in accordance with the kind of the resin, optimal resin removing treatment can be performed. In accordance with the kind of the resin to be removed and the fine metal particle 14, the same effect can be also obtained with plasma treatment by a single gas such as a fluorine gas, an oxygen gas, an argon gas and a chlorine gas. Further, the same effect can be obtained with plasma treatment by a mixture gas of proper combination of these gases. Further, when a part of the exposed fine metal particle 14 undergoes oxidation as a result of performing surface treatment by using these gases, additional surface treatment is performed with a gas capable of removing an oxide film on the fine particle surface, for example, an argon gas and a nitride gas, and a mixture gas of them, whereby the surface of the fine metal particle 14 is brought into a clean state, and favorable plating deposition can be made. Further, by performing additional reduction treatment with a reducing gas such as, for example, a hydrogen gas, and a mixture gas of a hydrogen gas, an argon gas and a nitrogen gas, an oxide film on the surface of the fine metal particle 14 is removed, and favorable plating deposition can be also made.

Here, the resin layer 12 is in the state in which the resin and the fine metal particles 14 mixedly exist, and before the surface treatment is applied, its surface is relatively flat. Before plating treatment step, in the surface of the resin layer 12, the surface treatment of selectively removing a part of the resin is applied to the surface of the resin layer 12 as described above to form microscopic irregularities on the surface and to increase the number and the distribution region of the fine metal particles 14 exposed to the surface, whereby even if the conductive metal layer 13 becomes thick, sufficient adhesion strength can be secured.

Subsequently, as shown in FIG. 3, the substrate 11 with the surface of the resin layer 12 processed by the surface treatment device 150 is conveyed to the electroless plating apparatus 200 by the conveyor means 250.

Next, processing in the electroless plating apparatus 200 will be described.

In the electroless plating apparatus 200, for example, electroless copper plating is performed, and the fine metal particles 14 act as a plating catalyst, whereby the conductive metal layer 13 by plating is deposited on the resin layer 12. Thereby, the conductor pattern 18 can be obtained. In this case, the electroless plating is not limited to electroless copper plating, and any electroless plating may be adopted as long as it can form the conductive metal layer 13 as electroless gold plating and electroless nickel plating. After electroless plating is performed, heavy deposition is made by electrolytic plating, and further reduction in resistance may be performed.

Further, without being limited to electroless plating, the conductive metal layer 13 may be formed by electrolytic plating. In this case, palladium, nickel, cobalt, gold, silver and the like which are catalysts of electroless plating may be used as a base layer for electrolyte plating. Fine metal particles such as chrome, zinc and lead, metal oxides such as a copper oxide and a nickel oxide, a carbide such as SiC, conductive fine particles composed of a conductive polymer, and the like, which do not serve a catalyst function may be properly selected and contained in the base layer.

Here, a thickness (D1) of the resin layer 12 which constructs the conductor pattern 18 is 0.3 to 2 μm, thickness (D2) of the conductive metal layer 13 is 3 to 30 μm, and the ratio of D2 and D1 (D2/D1) is preferably 1.5 to 100. The ratio of D2 and D1 (D2/D1) is set to be in this range because when the ratio of D2 and D1 is smaller than 1.5, thickness of the conductive metal layer 13 is small, wiring resistance becomes large and a favorable circuit board is not sometimes formed, while when it is larger than 100, thickness of the resin layer 12 becomes small, and the adhesion strength with the substrate sometimes becomes small.

According to the circuit board 10 of the above described first embodiment, after the resin layer 12 containing the fine metal particles 14 is formed, surface treatment of the resin layer 12 is performed by using plasma, a part of the resin is selectively removed, and fine irregularities of which the maximum height (Rz) per reference length (1r) of 1 μm is 20 nm to 500 nm can be formed. At the same time as formation of the microscopic irregularities, the number and the distribution region of the fine metal particles 14 which are exposed to the surface of the resin layer 12 and function as the plating catalyst can be increased. By formation of these microscopic irregularities and increase in the number and distribution region of the exposed fine metal particles 14, strong adhesion of the resin layer 12 and the conductive metal layer 13 can be secured. Further, in the interface between the resin layer 12 and the conductive metal layer 13, the conductive metal layer 13 which substantially follows the surface with the microscopic irregularities of the region where the resin and the fine metal particles 14 mixedly exist is formed, and adhesion between the resin layer 12 and the conductive metal layer 13 is further strengthened by the anchoring effect.

Since in this embodiment, the pattern can be formed on the substrate by shearing transfer, scattering of the developer such as the metal dispersed resin particles 17 hardly occurs, and the pattern with high-resolution can be formed. In this case, the particle size of the metal dispersed resin particle 17 contained in the liquid toner is about 1 μm at the maximum, and therefore, a fine pitch pattern with high accuracy can be formed. In this embodiment in which the pattern is formed by the wet type, by using the laser exposure device having accuracy of about 1200 dpi, formation of a fine pitch pattern of L (line)/S (space)=30 μm/30 μm is realized.

Though in the above described first embodiment, the circuit board 10 on which the conductor pattern 18 is formed is mainly described, but an insulation pattern can be formed on the substrate by supplying a liquid toner containing resin particles formed of only the resin which composes the aforementioned metal dispersed resin particle 17 from the developing device of the pattern forming apparatus 100, for example. In the pattern forming apparatus 100, both the developing device which supplies the liquid toner containing the aforementioned metal dispersed resin particles 17, and the developing device which supplies the liquid toner containing the resin particles formed of only the resin which composes the aforementioned metal dispersed resin particle 17 are included, and thereby, the circuit board 10 including both the conductor pattern 18 and the insulation pattern can be formed. Further, the conductor pattern 18 and the insulation pattern are further formed on the circuit including both the conductor patter 18 and the insulation pattern, and thereby, a multilayer circuit board having the multilayer circuit can be formed.

### Second Embodiment

In a second embodiment, the case where a conductor pattern is formed by using a dry type developing device will be described.

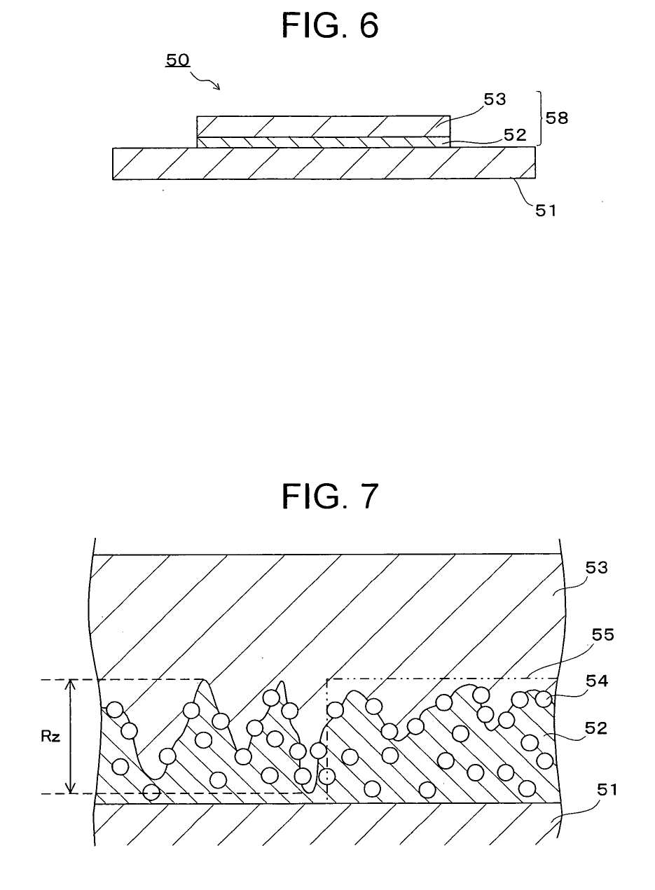

FIG. 6 schematically shows a section of a circuit board 50 of the second embodiment of the present invention. FIG. 7 schematically shows a section of an interface of a resin layer 52 and a conductive metal layer 53 under magnification.

As shown in FIGS. 6 and 7, the circuit board 50 is constructed by a substrate 51, the nonconductive resin layer 52 which is selectively formed on the substrate 51 and contains fine metal particles 54, and a conductive metal layer 53 which is formed in contact with the fine metal particles 54 exposed from the resin layer 52, on the resin layer 52. In this case, a conductor pattern 58 is formed by the resin layer 52 that is a base pattern, and the conductive metal layer 53 that is a plating deposition film.

In this case, resins which form the substrate 51 and the resin layer 52, and a material which composes the fine metal particles 54 are respectively the same as the resins which form the substrate 11 and the resin layer 12, and the material which composes the fine metal particles 14 in the first embodiment.

In this embodiment using the dry type developing device, the particle size of the fine metal particle 54 is 5 nm to 500 nm. In this case, the particle size of the fine metal particle 54 is set in this range because when the particle size is smaller than 5 nm, the adhesive force to the surface of the resin particle 56 becomes weak, and when the particle size is larger than 500 nm, the development characteristics of a metal dispersed resin particle 57 degrage. A more preferable range of the particle size is 10 nm to 300 nm.

As shown in FIG. 7, in the interface between the resin layer 52 and the conductive metal layer 53, the surface of the resin layer 52 has irregularities as a result of the surface treatment being applied thereto. These irregularities are defined based on the standards of JIS B 0601 (2001) as in the case of the first embodiment, and in the roughness curve of the section of the resin layer 52, in the case of the wavelength (λc) at the boundary of the roughness component and the waviness component is 4 μm, the maximum height (Rz) per reference length (1r) of 4 μm is 20 nm to 1 μm.

In this case, the range of the maximum height (Rz) is set to be 20 nm to 1 μm because when the maximum height (RZ) is smaller than 20 nm, selective removal of the resin is insufficient on the occasion of performing surface treatment, and exposure of the fine metal particles 54 decreases, thus making it impossible to obtain the conductive metal layer 53 that is a favorable plating deposition film. When it is larger than 1 μm, it becomes difficult for the resin to hold the fine metal particles 54 due to the selective removal of the resin by the surface treatment, and the favorable conductive metal layer 53 cannot be obtained. A more preferable range of the maximum height (Rz) is 400 nm to 1 μm. By having the maximum height (Rz) in the range of 400 nm to 1 μm, it becomes possible to increase the exposed fine metal particles 54 while leaving the resin to some degree.

In the section of the resin layer 52, the number (N) of fine metal particles 54, which exist in a region 55 in a rectangular shape enclosed by sides of a length of 1 μm in the direction parallel with the surface of the substrate 51 and sides of a length of 300 nm in the direction perpendicular to the surface of the substrate 51 and including the surface of the resin layer 52, and are at least partially in contact with the conductive metal layer 53, is preferably 3 to 500 in the average value in 10 spots. This range of the number is preferable because when the number (N) of fine metal particles 54 is smaller than three, exposure frequency of the fine metal particles 54 after surface treatment becomes low even if the fine metal particles 54 of several hundreds nm order (300 nm to 500 nm) are used, and the conductive metal layer 53 that is a favorable plating deposition film cannot be obtained. When the number of fine metal particles 54 is larger than 500, the amount of resin included in the resin layer 52 becomes small even if the extremely fine metal particles 54 of several nm order (5 nm to 40 nm) are used, which makes it difficult to hold the fine metal particles 54, and therefore, the favorable conductive metal layer 53 can not be obtained. Further, a preferable range of the number (N) of fine metal particles 54 at least partially in contact with the conductive metal layer 53 is 18 to 60. By having the fine metal particles 54 ranging in number from 18 to 60, it is possible to simultaneously take advantage of adhering function of the resin while securing the sufficient number of fine metal particles 54, and the favorable conductive metal layer 53 is obtained.

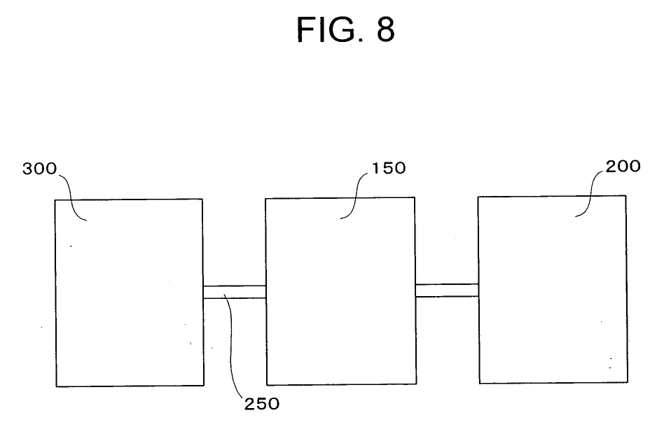

Next, one example of a forming process of the circuit board 50 will be described with reference to FIGS. 8 to 10.

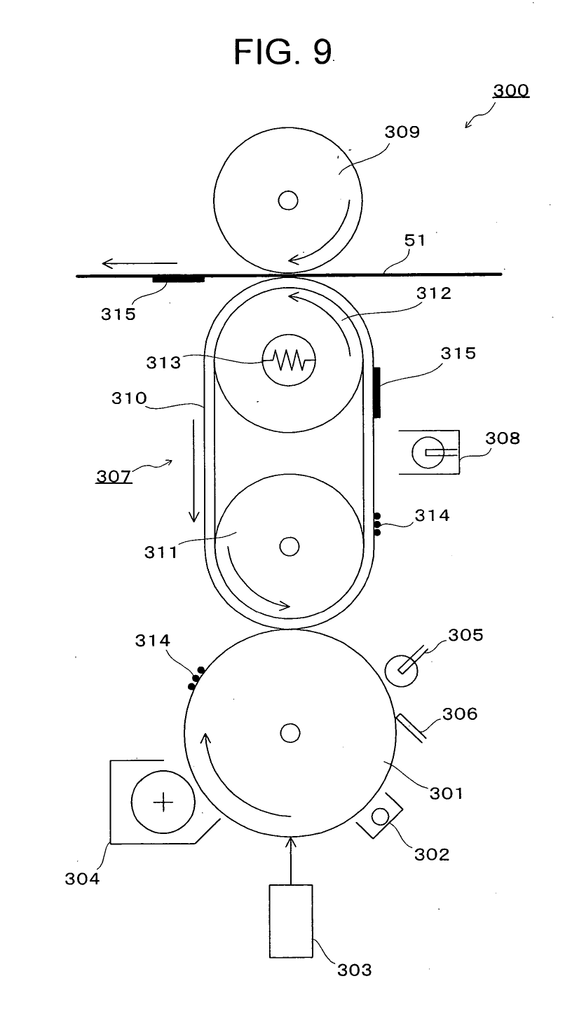

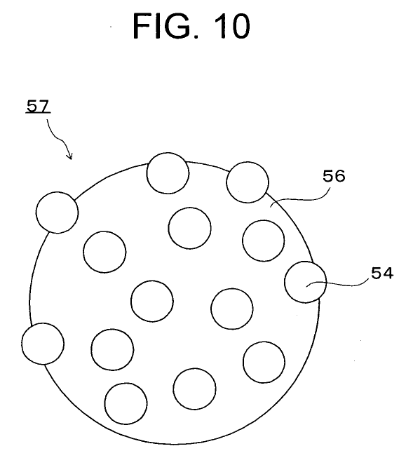

FIG. 8 is a view schematically showing an entire manufacturing apparatus of the circuit board 50 of the second embodiment. FIG. 9 is a view schematically showing a pattern forming apparatus 300. FIG. 10 is a plane view showing the metal dispersed resin particle 57 with the fine metal particles 54 adhering to the surface of the resin particle 56.

As shown in FIG. 8, the manufacturing apparatus of the circuit board 50 is constructed by the pattern forming apparatus 300, the surface treatment apparatus 150, the electroless plating apparatus 200 and the carrier means 250, and the circuit board 50 under manufacture is conveyed to each of the apparatuses by the carrier means 250. The surface treatment apparatus 150, the electroless plating apparatus 200 and the carrier means 250 are the same as the manufacturing apparatus of the circuit board 10 of the first embodiment 1.

First, referring to FIG. 9, the pattern forming apparatus 300 will be described.

As shown in FIG. 9, the pattern forming apparatus 300 is mainly constructed by a photoreceptor drum 301, an electrifier 302, a laser exposure device 303, a developing device 304, a photoreceptor cleaner 305, a static eliminator 306, an intermediate transfer medium 307, a toner image heater 308 and a pressure roller 309. In this case, the intermediate transfer medium 307 is constructed by an intermediate transfer belt 310 and transfer rollers 311 and 312, and a heater 313 such as a halogen lamp is provided in the transfer roller 312. As the toner image heater 308, light emitting means which heats with light may be provided to be noncontact as shown in FIG. 9, or a heat roller having a heater inside may be provided in contact with the intermediate transfer belt 310.

Here, the metal dispersed resin particle 57 that is a powder toner supplied from the dry type developing device 304 will be described.

FIG. 10 is a plane view showing the metal dispersed resin particle 57. As shown in FIG. 10, the metal dispersed resin particle 57 is constructed by causing the aforementioned fine metal particles 54 to adhere to the surface of the resin particle 56.

The particle size of the resin particle 56 is 4 to 8 μm. In this case, the particle size of the resin particle 56 is set in this range because when the particle size is smaller than 4 μm, development properties degrade due to flocculation of the metal dispersed resin particles 57, and when the particle size is larger than 8 μm, a large amount of metal dispersed resin particles 57 scatter to the non-developed part to make it difficult to form fine pitch patterns. A more preferable range of the particle size of the resin particle 56 is 4 to 6 μm. In this case, the ratio of the fine metal particles 54 dispersing to the resin particle 56 is 1.5 to 50 weight %. The ratio of the fine metal particles 54 is set in this range because when the ratio is lower than 1.5 weight %, distribution frequency of the fine metal particles 54 contained in the resin layer 52 is insufficient, exposure of the fine metal particles 54 is small after surface treatment, and the conductive metal layer 53 that is a favorable plating deposition film cannot be obtained, while when the ratio is higher than 50 weight %, a preferable visible image is not sometimes formed on the occasion of forming the visible image on the photoreceptor drum 301 by the metal dispersed resin particles 57.

Next, with reference to FIG. 9, a forming process of the conductor pattern 58 by the pattern forming apparatus 300 will be described.

First, the photoreceptor drum 301 is electrically charged uniformly to make the surface potential of the photoreceptor drum 301 a constant potential (for example, a negative charge) by the electrifier 302 while the photoreceptor drum 301 is rotated in the arrow direction. The concrete electrifying method includes the scorotron charging method, the roller charging method, the brush charging method and the like. Next, by the laser exposure device 303, laser light is irradiated to the photoreceptor drum 301 in accordance with the image signal to remove the negative charge at the irradiated portion, and the charge image (electrostatic latent image) of a predetermined pattern is formed on the surface of the photoreceptor drum 301.

Next, the metal dispersed resin particles 57 which are the powder toner electrically charged by the developing device 304 are caused to electrostatically adhere to the electrostatic latent image on the photoreceptor drum 301, and the powder toner image 314 which is a visible image is formed. The dry type toner transfer technique in a known electrophotographic copying system can be applied to the developing device 304.

A predetermined transfer voltage is applied to the transfer roller 311, and the powder toner image 314 is transferred onto the intermediate transfer belt 310 by an electric field formed between the photoreceptor drum 301 and the intermediate transfer belt 310. The photoreceptor drum 301 passes the photoreceptor cleaner 305 after the transfer processing, and has its surface cleaned, and the photoreceptor drum 301 further passes the static eliminator 306, and has its electrified charge removed to proceed to the next pattern forming operation.

The powder toner image 314 which is transferred onto the intermediate transfer belt 310 receives heat supply when passing by the toner image heater 308, and melted to be a film. A toner image 315 which is made a film is subjected to an action of the pressure applied between the transfer roller 312 and the pressure roller 309. Thereby, the toner image 315 on the intermediate transfer belt 310 is easily transferred onto the substrate 51, and the resin layer 52 containing the fine metal particles 54 is formed.

The toner image transferred onto the intermediate transfer belt 310 is offset-transferred onto the conveyed substrate 51 by pressing the pressure roller 309 with the load of, for example, 100 kg. The surface of the transfer roller 312 is heated to about 100° C. by a heater such as a halogen lamp provided inside.

In the pattern forming apparatus 300 adopting the electrophotographic method by the dry type using the powder toner as a developer, the powder toner image 314 is usually processed in the powder state until it is heat-fixed on the substrate 51, and by making the toner a film by thermal fusion in the intermediate process as in this embodiment, image disturbance caused by scattering of the toner during transfer can be eliminated. Thereby, it is possible to obtain the image of higher image quality.

In this embodiment, the construction using the intermediate transfer belt 310 as the intermediate transfer medium 307 is shown, but as in the first embodiment, the intermediate transfer medium 307 may be constructed by sticking an elastic film onto the surface of the hollow roller made by SUS which is a rigid roller. A construction in which the powder toner image 314 on the photoreceptor drum 301 is directly transferred onto the substrate 51 without using the intermediate transfer medium 307 may be adopted. In this case, the toner image heater 308 is provided downstream of the developing device 304, and heats and melts the powder toner image 314 on the photoreceptor drum 301 into a film to transfer it directly to the substrate 51 with pressure and heat. Though not shown, a heater is disposed in the carrier path of the substrate 51, and sufficiently heats the substrate in advance, so that the transfer efficiency may be enhanced.

Subsequently, as shown in FIG. 8, the substrate 51 on which the resin layer 52 containing the fine metal particles 54 is formed by the pattern forming apparatus 300 is conveyed to the surface treatment device 150 by the carrier means 250. The substrate 51 which has the surface of the resin layer 52 treated in the surface treatment apparatus 150 is conveyed to the electroless plating apparatus 200 by the carrier means 250, where it is subjected to electroless plating processing, and the conductive metal layer 53 is formed on the resin layer 52. In this case, the treatment and processing in the surface treatment apparatus 150 and the electroless plating apparatus 200 is the same as the treatment and processing of those in the first embodiment.

Here, a thickness (D1) of the resin layer 52 constructing the conductor pattern 58 is 4 to 20 μm, a thickness (D2) of the conductive metal layer 53 constructing the conductor pattern 58 is 3 to 30 μm, and the ratio of D2 and D1 (D2/D1) is preferably 0.15 to 7.5. The ratio of D2 and D1 (D2/D1) is set in this range because when the ratio of D2 and D1 is smaller than 0.15, the thickness of the conductive metal layer 53 is small, wiring resistance becomes large, and a favorable circuit board is not sometimes formed, while when it is larger than 7.5, the thickness of the conductive metal layer 53 becomes large, stress in the conductive metal layer becomes large, and peeling-off sometimes occurs in the interface with the resin layer 52.

According to the circuit board 50 of the above described second embodiment, after the resin layer 52 containing the fine metal particles 54 is formed, surface treatment of the resin layer 52 is performed by using plasma, a part of the resin is selectively removed, and microscopic irregularities of which maximum height (Rz) per reference length (1r) of 4 μm is 20 nm to 1 μm can be formed. At the same time as formation of the microscopic irregularities, the number and the distribution region of the fine metal particles 54, which are exposed from the surface of the resin layer 52 and function as the plating catalyst, can be increased. By formation of these microscopic irregularities and increase in the number and distribution region of the exposed fine metal particles 54, strong adhesion of the resin layer 52 and the conductive metal layer 53 can be ensured. Further, in the interface between the resin layer 52 and the conductive metal layer 53, the conductive metal layer 53 which substantially follows the surface with the microscopic irregularities of the region where the resin and the fine metal particles 54 mixedly exist is formed, and adhesion of the resin layer 52 and the conductive metal layer 53 is further strengthened by the anchoring effect.

Since in this embodiment, the pattern can be formed on the substrate by shearing transfer, scattering of the developer such as the metal dispersed resin particles 57 hardly occurs, and the pattern with high-resolution can be formed. In this case, the particle size of the metal dispersed resin particle 57 that is the powder toner is about 8 μm at the maximum, and therefore, a fine pitch pattern with high accuracy can be formed. In this embodiment which forms the pattern by the dry type, by using the laser exposure device having accuracy of about 1200 dpi, formation of a fine pitch pattern of L(line)/S (space)=80 μm/80 μm is realized.

Though in the above described second embodiment, the circuit board 50 on which the conductor pattern 58 is formed is mainly described, but an insulation pattern can be formed on the substrate by supplying resin particles formed of only the resin which composes the aforementioned metal dispersed resin particle 57, from the developing device 304 of the pattern forming apparatus 300, for example. Then, by combining the forming process of the conductor pattern and the forming process of the insulation pattern, the circuit board 50 including both the conductor pattern 58 and the insulation pattern can be formed. Further, the conductor pattern 58 and the insulation pattern are further formed on the circuit including both the conductive patter 58 and the insulation pattern, and thereby, a multilayer circuit board having the multilayer circuit can be formed.

### Third Embodiment

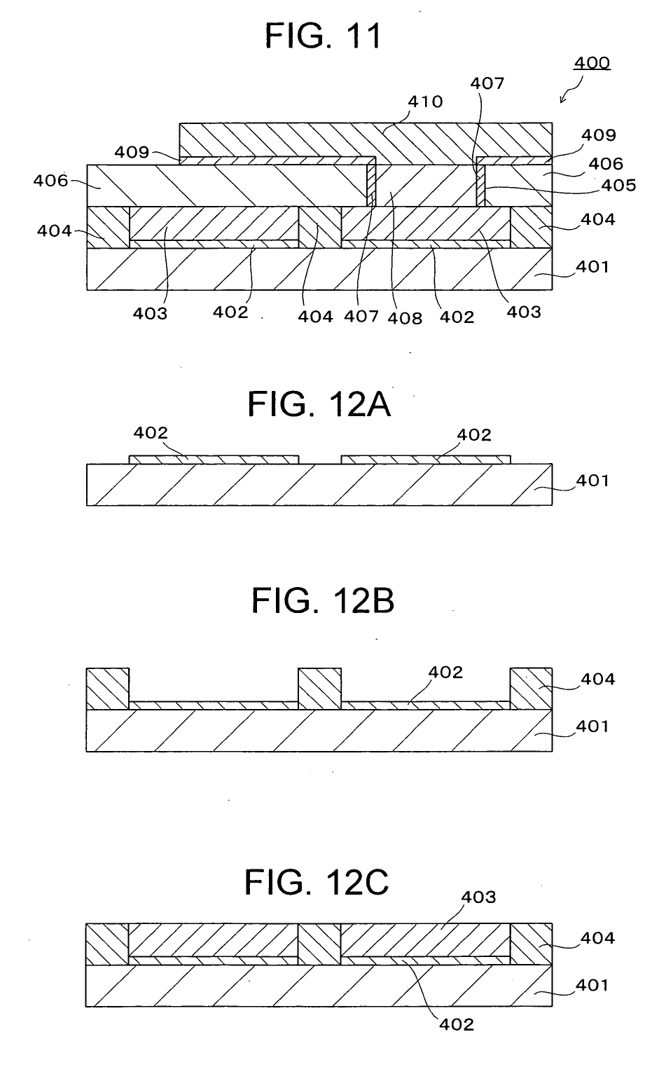

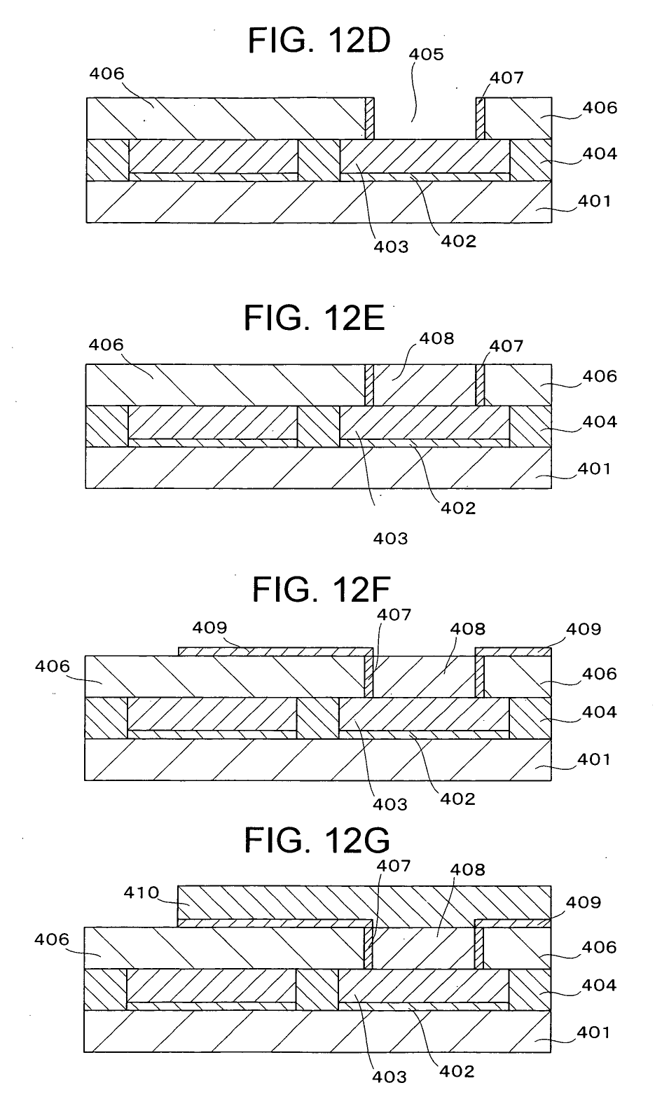

In this case, a multilayer circuit board formed based on the manufacturing apparatus and the manufacturing method of the circuit board shown in the above described first or second embodiment, and its forming process will be described with reference to FIG. 11, and FIGS. 12A to 12G. In this case, one example using the manufacturing apparatus used for forming the circuit board 10 in the first embodiment will be shown.

FIG. 11 is a view schematically showing a section of a multilayer circuit board 400. FIGS. 12A to 12G are views schematically showing sections in the respective forming steps of the multilayer circuit board 400. In this case, the nonconductive layer containing the fine metal particles, which is called the resin layer in the first and second embodiment, will be called a metal containing resin layer. The nonconductive layer formed of only a resin is called an insulation layer.

As shown in FIG. 11, in the multilayer circuit board 400, a first conductor pattern constituted of a first metal containing resin layer 402 and a first conductive metal layer 403 formed on the first metal containing resin layer 402, and a first insulation pattern constituted of a first insulation layer 404 formed adjacently to the first conductor pattern are formed on a substrate 401 as a first layer. On the first layer, as a second layer, a through-hole 405 is formed in a desired position on the first conductor pattern, and a second insulation layer 406 is formed in the same layer as the through-hole 405. In the through-hole 405, a second metal containing resin layer 407 is formed along its wall surface, and a conductive layer 408 is formed to fill an inside of the second metal containing resin layer 407. Further, on the second layer, as a third layer, a second conductor pattern constituted of a third-metal containing resin layer 409, and a second conductive metal layer 410 formed on the third metal containing resin layer 409 and on the conductive layer 408 is formed.

Next, one example of each of the forming step of the multilayer circuit board 400 will be described.

In this case, the pattern forming apparatus 100 shown in FIG. 4 is used, and the pattern forming apparatus 100 includes a developing device housing a conductor liquid toner containing the metal dispersed resin particles 17 in the solvent to form the conductor pattern, and a developing device housing an insulating liquid toner containing resin particles in the solvent to form the insulation pattern, as developing devices.

First, development by the conductor liquid toner for forming the first metal containing resin layer 402 is performed on the photoreceptor drum 101. The developed conductor liquid toner image goes through the drying step and the transfer step to be transferred to the substrate 401, and the first metal containing resin layer 402 is formed on the substrate 401. Subsequently, the substrate 401 on which the first metal containing resin layer 402 is formed is conveyed to the surface treatment apparatus 150 shown in FIG. 3, and the surface of the first metal containing resin layer 402 is treated (FIG. 12A). Irregularities are formed on the surface of the first metal containing resin layer 402 after the surface treatment, and some of a plurality of fine metal particles 14 are exposed from the surface with the irregularities.

Subsequently, the substrate is conveyed to the patter forming apparatus 100, and in the same step as the step of forming the aforementioned first metal containing resin layer 402, the first insulation layer 404 is formed by using the insulating liquid toner (FIG. 12B).

Subsequently, the substrate 401 with the first insulation layer 404 formed is conveyed to the electroless plating apparatus 200, and is immersed in a copper electroless plating bath, and the first conductive metal layer 403 that is an electroless copper plating layer is deposited on the first metal containing resin layer 402, whereby the first conductor pattern is formed and the first layer is formed (FIG. 12C).

Next, the step proceeds to the forming process of the second layer of the multilayer circuit board 400. The substrate 401 on which the first layer is formed is conveyed to the pattern forming apparatus 100. Development by the insulating liquid toner for forming the second insulation layer 406 is performed except for the formation portion of the through-hole 405, and at the same time as this, development by the conductor liquid toner to form the second metal containing resin layer 407 is performed along the inner wall of the through-hole 405. The developed insulating liquid toner image and conductor liquid toner image go through the drying step and the transfer step and are transferred onto the first layer of the substrate 401, and the second insulation layer 406 and the second metal containing resin layer 407 are formed. In the forming step of the second layer, printing of the insulating liquid toner layer and the conductor liquid toner layer is repeatedly performed, and thereby, the second insulation layer 406 and the second metal containing resin layer 407 can be formed into the desired thickness.

Subsequently, the substrate 401 above which the second insulation layer 406 and the second metal containing resin layer 407 are formed is conveyed to the surface treatment apparatus 150 shown in FIG. 3, and the surface of the second metal containing resin layer 407 is treated (FIG. 12D). Irregularities are formed on the surface of the second metal containing resin layer 407 after surface treatment, and some of a plurality of fine metal particles 14 are exposed from the surface with the irregularities.

Subsequently, the substrate 401 above which the second metal containing resin layer 407 is formed is conveyed to the electroless plating apparatus 200, is immersed in a copper electroless plating bath, and the conductive layer 408 that is the electroless copper plating layer is deposited on the second metal containing resin layer 407. Then the second layer is formed (FIG. 12E).

Next, the step proceeds to the forming process of the third layer of the multilayer-circuit board 400. The substrate 401 on which the first layer and the second layer are formed is conveyed to the pattern forming apparatus 100. Development by the conductor liquid toner to form the third metal containing resin layer 409 is performed on the photoreceptor drum 101. The developed conductor liquid toner image goes thorough the drying step and the transfer step to be transferred onto the second layer, and the third metal containing resin layer 409 is formed. Subsequently, the substrate 401 above which the third metal containing resin layer 409 is formed is conveyed to the surface treatment apparatus 150 shown in FIG. 3, and the surface of the third metal containing resin layer 409 is treated (FIG. 12F). Irregularities are formed on the surface of the third metal containing resin layer 409 after the surface treatment, and some of a plurality of fine metal particles 14 are exposed from the surface with the irregularities.

Subsequently, the substrate 401 above which the third metal containing resin layer 409 is formed is conveyed to the electroless plating apparatus 200, immersed in a copper electroless plating bath, the second conductive metal layer 410 that is an electroless copper plating layer is deposited on the third metal containing resin layer 409, and the third layer is formed (FIG. 12G).

As described above, by repeatedly forming the conductor patterns and insulating patterns, an optional multilayer circuit board can be formed. After the metal containing resin layer containing the fine metal particles is formed, surface treatment of the metal containing resin layer is performed by using plasma, a part of the resin is selectively removed, and microscopic irregularities can be formed. At the same time as the microscopic irregularities are formed, the number and distribution region of the fine metal particles which are exposed from the surface of the metal containing resin layer and function as the plating catalyst can be increased. By formation of these microscopic irregularities and increase in the number and distribution region of the fine metal particles which are exposed, strong adhesion of the metal containing resin layer and the conductive metal layer can be ensured. Further, in the interface of the metal containing resin layer and the conductive metal layer, the conductive metal layer which substantially follows the surface with the microscopic irregularities of the region where the resin and the fine metal particles mixedly exist is formed, and adhesion of the metal containing resin layer and the conductive metal layer is further strengthened by the anchoring effect.

The construction of the above described multilayer circuit board 400 shows one example, and the construction of the multilayer circuit board is not limited to this construction. In this case, the forming process of the multilayer circuit board is described, but this forming process can be adopted when a single layer circuit board is formed. Further, in the forming process of the above described multilayer circuit board, one example of forming the patterns by the wet type development is shown, but the pattern forming process by the dry type development as shown in the second embodiment can be adopted.

Next, concrete examples of the present invention will be described.

Fist, the conductor patterns formed by the wet type development will be shown in example 1 to example 7, comparative examples 1 and 2. The construction of the substrate used as the sample substrate here is the same as the construction of the circuit board shown in FIG. 1, and therefore, it will be described with reference to FIG. 1. The construction of the metal dispersed resin particle contained in the liquid toner used here is the same as the construction of the metal dispersed resin particle shown in FIG. 5, and therefore, it will be described with reference to FIG. 5.

### EXAMPLE 1

In Example 1, as a liquid toner, the one containing the metal dispersed resin particles 17 in a known petroleum insulating solvent (trade name; Isopar L, made by Exxon Corporation) was used. Here, the metal dispersed resin particle 17 is the one with the fine metal particles 14 composed of fine Ag particles with an average particle size of 5 nm dispersing to the acrylic resin particle 16. The rate of content of the fine metal particles 14 was set at 50 weight % with respect to the weight of the resin particle 16, and the covering rate of the fine metal particles 14 to one resin particle was about 29%. A charge control agent was added to the surface of the metal dispersed resin particle 17.

First, as in the forming process of the resin layer described in the first embodiment, the resin layer 12 of a thickness of 500 nm, a width of 20 μm, and a space of 20 μm was formed on the substrate 11 formed of a polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250 and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 20 seconds.

By this surface treatment, in the irregularities on the surface of the resin layer 12, the maximum height (Rz) per reference length (1r) of 1 μm was 300 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that is the electroless plating layer was formed on the resin layer 12. Here, the thickness of the conductor pattern 18 composed of the resin layer 12 and the conductive metal layer 13 was 10 μm.

Annealing treatment for two hours at 180° was applied to the conductor pattern 18 formed as described above. The volume resistivity of the conductor pattern 18 after the annealing treatment was about 1.75×10⁻⁶ Ω/cm.

The degree of adhesion of the conductive metal layer 13 to the resin layer 12 was measured by the Instron type tension testing machine. As s result, the tensile strength was 150 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscopic irregularities of the resin layer 12 were in contact with the conductive metal layer 13. The number (N) of fine metal particles 14, which existed in the region in a rectangular shape enclosed by sides of a length of 1 μm in the direction parallel with the surface of the substrate 11 and sides of a length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 500 in the average value in 10 spots. Here, the fine metal particles 14 which were partially included in the specified rectangular region were counted in the number.

The thickness (D1) of the resin layer 12 was 500 nm, the thickness (D2) of the conductive metal layer 13 was 9.5 μm, and the ratio of D2 and D1 (D2/D1) was 19.

Further, the cover layer formed of the polyimide resin film was laminated on the conductor pattern 18 on the substrate 11, and the flexible wiring board was formed. As a result of carrying out the bending test of the JIS standards for the substrate 11, it was proved that the favorable wiring board without breaking of wire was formed.

Here, in the above described liquid toner, the attached amount of the fine Ag particles in the metal dispersed resin particle 17 was increased, and the one with the number (N) of fine metal particles 14, which existed in the region in the rectangular shape enclosed by the sides of the length of 1 μm in the direction parallel with the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, exceeded 500 (580) in the average value in the ten spots, was made by way of experiment, and formation of the conductor pattern 18 was tried. However, under the conditions, the electrification characteristics were not stabilized, development characteristics became bad, and the fine pattern of the resin layer 12 was not able to be formed.

(Example of Wet Type Electric Field Transfer)

Here, in the above described embodiment, the shearing transfer in which the visible image formed on the photoreceptor by using the wet type developing device is transferred on the intermediate transfer base with heating and pressure without using an electric field is described, but when the pattern is relatively large, the step of transferring the image onto the intermediate transfer base by using an electric field may be used. For example, when the line width L is 50 μm or more, and the space S is 80 μm or more, the influence of scattering of the toner particles by the electric field is relatively small, and the formation of a sufficiently practical pattern is possible by electric field transfer. The pattern forming apparatus by the wet type electric field transfer is the same as the pattern forming apparatus by the wet type shearing transfer in the construction of the exposure/development/drying steps, the secondary transfer step, and the cleaning step, though they differ in the construction of the intermediate transfer roller 108. The toner image heater that heats the toner image after transfer is provided in the vicinity of the intermediate transfer roller. Explaining by using FIG. 4, a heater is additionally provided as the toner image heater at the side opposite from the intermediate cleaning roller 10 of the intermediate transfer roller 108. The intermediate transfer base of the pattern forming apparatus of the wet type electric field transfer has the construction in which the elastic film is stuck to the surface of the hollow roller made by SUS that is a rigid roller, and the elastic film desirably has conductivity of the volume resistivity of about 10⁴ to 10¹⁰ Ω·cm to enhance the transfer efficiency. A predetermined transfer voltage is applied to the intermediate transfer roller, and after the wet type toner image is dried into a predetermined dried state on the photoreceptor drum 101, it is transferred onto the intermediate transfer roller by the electric field formed between the photoreceptor drum 101 and the intermediate transfer roller. At this time, the speed difference between the photoreceptor drum 101 and the intermediate transfer roller not as in the shearing transfer is not required. The toner image transferred onto the intermediate transfer roller receives heat supply when it passes the toner image heater, and is melted to be a film. The toner image which is made a film receives the action of the pressure applied between the transfer roller and pressure roller, is easily transferred onto the substrate 51, and the resin layer 12 containing the fine metal particles 14 is formed.

The resin layer 12 containing the fine metal particles 14 formed on the substrate goes through the surface treatment step and the plating step, and has the conductor pattern formed, and these steps are the same as the wet type shearing transfer as described above.

(Example of Direct Transfer of Wet Type Electric Field)

As described above, the two-stage transfer method in which the toner image is transferred by applying the electric field between the photoreceptor and the intermediate transfer roller, and after the toner image is melted, it is transferred onto the substrate, is described, but when the line width and the space are relatively large, a direct transfer method for transferring by applying an electric field between the photoreceptor and the backup roller without using the intermediate transfer roller may be adopted. In this case, a hollow metal roller is used as the backup roller, the toner image is properly dried on the photoreceptor, and the substrate is inserted with an electric field applied between the backup roller and the photoreceptor, whereby the toner image is directly transferred to the substrate. After transferred to the substrate, the toner image may be heated as necessary, and thereby, fixation is enhanced.

### EXAMPLE 2

In Example 2, as the liquid toner, the same liquid toner as in Example 1 was used. First, as in the forming process of the resin layer described in the first embodiment, the resin layer 12 of a thickness of 300 nm, a width of 10 μm, and a space of 10 μm was formed on the substrate 11 formed of a polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 20 W for 5 seconds.

By this surface treatment, in the irregularities on the surface of the resin layer 12, the maximum height (Rz) per reference length (1 r) of 1 μm was 20 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that was the electroless plating layer was formed on the resin layer 12. Here, the thickness of the conductor pattern 18 composed of the resin layer 12 and the conductive metal layer 13 was 10 μm.

Annealing treatment for two hours at 180° was applied to the conductor pattern 18 formed as described above. The volume resistivity of the conductor pattern 18 after the annealing treatment was about 1.75×10⁻⁶ Ω·cm.

The degree of adhesion of the conductive metal layer 13 to the resin layer 12 was measured by the Instron type tension testing machine. As s result, the tensile strength was 100 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscopic irregularities of the resin layer 12 were in contact with the conductive metal layer 13. The number (N) of fine metal particles 14, which existed in the region in the rectangular shape enclosed by the sides of the length of 1 μm in the direction parallel with the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 120 in the average value in 10 spots. Here, the fine metal particles 14 which were only partially included in the specified rectangular region were counted in the number.

The thickness (D1) of the resin layer 12 was 300 nm, the thickness (D2) of the conductive metal layer 13 was 9.7 μm, and the ratio of D2 and D1 (D2/D1) was 32.

### EXAMPLE 3

In Example 3, as a liquid toner, the one containing the metal dispersed resin particles 17 in a known petroleum insulating solvent (trade name; Isopar L, made by Exxon Corporation) was used as in Example 1. Here, the metal dispersed resin particle 17 is the one with the fine metal particles 14 composed of fine Ag particles of an average particle size of 10 nm dispersing to the acrylic resin particle 16 which is a thermoplastic resin of the average particle size of 0.2 μm. The rate of content of the fine metal particles 14 was set at 50 weight % with respect to the weight of the resin particle 16, and the covering rate of the fine metal particles 14 to one resin particle was about 29%. The charge control agent was also added to the surface of the metal dispersed resin particle 17.

First, as in the forming process of the resin layer described in the first embodiment, the resin layer 12 of a thickness of 300 nm, a width of 10 μm, and a space of 10 μm was formed on the substrate 11 formed of the polyimide resin by using the above described liquid toner by the pattern forming apparatus 100.

Next, as shown in FIG. 3, the substrate 11 on which the resin layer 12 was formed was conveyed to the surface treatment apparatus 150 by the conveyor means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 10 seconds.

By this surface treatment, in the irregularities on the surface of the resin layer 12, the maximum height (Rz) per reference length (1 r) of 1 μm was 150 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that was the electroless plating layer was formed on the resin layer 12. Here, the thickness of the conductor pattern 18 composed of the resin layer 12 and the conductive metal layer 13 was 10 μm.

Annealing treatment for two hours at 180° was applied to the conductor pattern 18 formed as described above. The volume resistivity of the conductor pattern 18 after the annealing treatment was about 1.75×10⁻⁶ Ω·cm.

The degree of adhesion of the conductive metal layer 13 to the resin layer 12 was measured by the Instron type tension testing machine. As a result, the tensile strength was 200 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscopic irregularities of the resin layer 12 were in contact with the conductive metal layer 13. The number (N) of fine metal particles 14, which existed in the region in the rectangular shape enclosed by the sides of the length of 1 μm in the direction parallel with the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 280 in the average value in 10 spots. Here, the fine metal particles 14 which were only partially included in the specified rectangular region were also counted in the number.

The thickness (D1) of the resin layer 12 was 300 nm, the thickness (D2) of the conductive metal layer 13 was 9.7 μm, and the ratio of D2 and D1 (D2/D1) was 32.

### EXAMPLE 4

In Example 4, as a liquid toner, the one containing the metal dispersed resin particles 17 in the known petroleum insulating solvent (trade name; Isopar L, made by Exxon corporation) was used, as in Example 1. Here, the metal dispersed resin particle 17 is the one with the fine metal particles 14 composed of fine Ag particles of an average particle size of 30 nm dispersing to the acrylic resin particle 16 which is a thermoplastic resin of the average particle size of 0.2 μm. The rate of content of the fine metal particles 14 was set at 50 weight % with respect to the weight of the resin particle 16, and the covering rate of the fine metal particles 14 to one resin particle was about 10%. The charge control agent was also added to the surface of the metal dispersed resin particle 17.

First, as in the forming process of the resin layer described in the first embodiment, the resin layer 12 of a thickness of 500 nm, a width of 20 μm, and a space of 20 μm was formed on the substrate 11 formed of the polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 30 seconds.

By this surface treatment, in the irregularities on the surface of the resin layer 12, the maximum height (Rz) per reference length (1r) of 1 μm was 400 nm when the wavelength (λc) at the border of the roughness component and the waviness component was 1μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that was the electroless plating layer was formed on the resin layer 12. Here, the thickness of the conductor pattern 18 composed of the resin layer 12 and the conductive metal layer 13 was 10 μm.

Annealing treatment for two hours at 180° was applied to the conductor pattern 18 formed as described above. The volume resistivity of the conductor pattern 18 after the annealing treatment was about 1.75×10⁻⁶ Ω·cm.

The degree of adhesion of the conductive metal layer 13 to the resin layer 12 was measured by the Instron type tension testing machine. As a result, the tensile strength was 200 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscopic irregularities of the resin layer 12 were in contact with the conductive metal layer 13. The number (N) of fine metal particles 14, which existed in the region in the rectangular shape enclosed by the sides of the length of 1 μm in the direction parallel to the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 120 in the average value in 10 spots. Here, the fine metal particles 14 which were only partially included in the specified rectangular region were also counted in the number.

The thickness (D1) of the resin layer 12 was 500 nm, the thickness (D2) of the conductive metal layer 13 was 9.5 μm, and the ratio of D2 and D1 (D2/D1) was 19.

### EXAMPLE 5

In Example 5, as a liquid toner, the one containing the metal dispersed resin particles 17 in the known petroleum insulating solvent (trade name; Isopar L, made by Exxon Corporation) was used, as in Example 1. Here, the metal dispersed resin particle 17 is the one with the fine metal particles 14 composed of fine Ag particles of an average particle size of 50 nm dispersing to the epoxy resin particle 16 which is a thermosetting resin of the average particle size of 0.5 μm. In this case, the epoxy resin particle 16 which was the base material of the metal dispersed resin particle 17 was in the half-cured state (so-called B stage state). The rate of content of the fine metal particles 14 was set at 50 weight % with respect to the weight of the resin particle 16, and the covering rate of the fine metal particles 14 to one resin particle was about 15%. The charge control agent was also added to the surface of the metal dispersed resin particle 17.

First, as in the forming process of the resin layer described in the first embodiment, the resin layer 12 of the thickness of 1 nm, the width of 30 μm, and the space of 30 μm was formed on the substrate 11 formed of the polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 60 seconds.

By this surface treatment, in the irregularities on the surface of the resin layer 12, the maximum height (Rz) per reference length (1 r) of 1 μm was 500 mm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that was the electroless plating layer was formed on the resin layer 12. Here, the thickness of the conductor pattern 18 composed of the resin layer 12 and the conductive metal layer 13 was 20 μm.

Annealing treatment for two hours at 250° was applied to the conductor pattern 18 formed as described above. The volume resistivity of the conductor pattern 18 after the annealing treatment was about 1.73×10⁻⁶ Ω·cm.

The degree of adhesion of the conductive metal layer 13 to the resin layer 12 was measured by the Instron type tension testing machine. As a result, the tensile strength was 250 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscope irregularities of the resin layer 12 were in contact with the conductive metal layer 13. The number (N) of fine metal particles 14, which existed in the region in the rectangular shape enclosed by the sides of the length of 1 μm in the direction parallel with the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 80 in the average value in 10 spots. Here, the fine metal particles 14 which were only partially included in the specified rectangular region were also counted in the number.

The thickness (D1) of the resin layer 12 was 1 μm, the thickness (D2) of the conductive metal layer 13 was 19 μm, and the ratio of D2 and D1 (D2/D1) was 19.

### EXAMPLE 6

In Example 6, as a liquid toner, the one containing the metal dispersed resin particles 17 in the known petroleum insulating solvent (trade name; Isopar L, made by Exxon Corporation) was used, as in Example 1. Here, the metal dispersed resin particle 17 is the one with the fine metal particles 14 composed of fine Ag particles of an average particle size of 100 nm dispersing to the epoxy resin particle 16 which is the thermosetting resin of an average particle size of 1 μm. In this case, the epoxy resin particle 16 which is the base material of the metal dispersed resin particle 17 was in the half-cured state (so-called B stage state). The rate of content of the fine metal particles 14 was set at 50 weight % with respect to the weight of the resin particle 16, and the covering rate of the fine metal particles 14 to one resin particle was about 15%. The charge control agent was also added to the surface of the metal dispersed resin particle 17.

First, as in the forming process of the resin layer described in the first embodiment, the resin layer 12 of a thickness of 2 μm, a width of 50 μm, and a space of 50 μm was formed on the substrate 11 formed of a polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 60 seconds.

By this surface treatment, in the irregularities on the surface of the resin layer 12, the maximum height (Rz) per reference length (1r) of 1 m was 500 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that was the electroless plating layer was formed on the resin layer 12. Here, the thickness of the conductor pattern 18 composed of the resin layer 12 and the conductive metal layer 13 was 20 μm.

Annealing treatment for two hours at 250° was applied to the conductor pattern 18 formed as described above. The volume resistivity of the conductor pattern 18 after the annealing treatment was about 1.73×10⁻⁶ Ω·cm.

The degree of adhesion of the conductive metal layer 13 to the resin layer 12 was measured by the Instron type tension testing machine. As s result, the tensile strength was 180 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscopic irregularities of the resin layer 12 were in contact with the conductive metal layer 13. The number (N) of the fine metal particles 14, which existed in the region in the rectangular shape enclosed by the sides of a length of 1 μm in the direction parallel with the surface of the substrate 11 and the sides of a length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 20 in the average value in 10 spots. Here, the fine metal particles 14 which were only partially included in the specified rectangular region were also counted in the number.

The thickness (D1) of the resin layer 12 was 2 μm, the thickness (D2) of the conductive metal layer 13 was 19 μm, and the ratio of D2 and D1 (D2/D1) was 9.5.

### EXAMPLE 7

In Example 7, as a liquid toner, the one containing the metal dispersed resin particles 17 in the known petroleum insulating solvent (trade name; Isopar L, made by Exxon Corporation) was used, as in Example 1. Here, the metal dispersed resin particle 17 was the one in which the fine metal particles 14 composed of fine Ag particles of an average particle size of 100 nm were caused to adhere to the surface of what was made by flocculating the acrylic resin particles 16 that was the thermoplastic resin of the average particle size of 0.2 μm to be the particle size of substantially 1 μm. The rate of content of the fine metal particles 14 was set at 50 weight % with respect to the weight of the resin particles 16, and the covering rate of the fine metal particles 14 to one resin particle was about 15%. The charge control agent was also added to the surface of the metal dispersed resin particle 17.

First, as in the forming process of the resin layer described in the first embodiment, the resin layer 12 of a thickness of 2 μm, a width of 50 μm, and a space of 50 μm was formed on the substrate 11 formed of the polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 45 seconds.

By this surface treatment, in the irregularities on the surface of the resin layer 12, the maximum height (Rz) per reference length (1r) of 1 μm was 500 nm when the wavelength (λc) of the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. Then, the conductive metal layer 13 that was the electroless plating layer was formed on the resin layer 12. Here, the thickness of the conductor pattern 18 composed of the resin layer 12 and the conductive metal layer 13 was 20 μm.

Annealing treatment for two hours at 180° was applied to the conductor pattern 18 formed as described above. The volume resistivity of the conductor pattern 18 after the annealing treatment was about 1.75×10⁻⁶ Ω·cm.

The degree of adhesion of the conductive metal layer 13 to the resin layer 12 was measured by the Instron type tension testing machine. As a result, the tensile strength was 150 MPa.

Further, the section of the interface of the resin layer 12 and the conductive metal layer 13 was observed by the SEM (Scanning Electron Microscope). As shown in FIG. 2, the result showed that the conductive metal layer 13, which was the plating film, was also formed in the recessed portions in the state in which it substantially followed the microscopic irregularities on the surface of the resin layer 12. The result also showed that the fine metal particles 14 exposed from the surface with the microscopic irregularities of the resin layer 12 were in contact with the conductive metal layer 13. The number (N) of fine metal particles 14, which existed in the region in the rectangular shape enclosed by the sides of the length of 1 μm in the direction parallel with the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 20 in the average value in 10 spots. Here, the fine metal particles 14 which were only partially included in the specified rectangular region were also counted in the number.

The thickness (D1) of the resin layer 12 was 2 μm, the thickness (D2) of the conductive metal layer 13 was 19 μm, and the ratio of D2 and D1 (D2/D1) was 9.5.

### COMPARATIVE EXAMPLE 1

In Comparative Example 1, as a liquid toner, the one containing the metal dispersed resin particles 17 in the known petroleum insulating solvent (trade name; Isopar L, made by Exxon Corporation) was used, as in Example 1. Here, the metal dispersed resin particle 17 was the one in which the fine metal particles 14 composed of fine Ag particles of an average particle size of 30 nm were caused to adhere to the surface of the acrylic resin particle 16 which was the thermoplastic resin of an average particle size of 0.2 μm. The rate of content of the fine metal particles 14 was set at 50 weight % with respect to the weight of the resin particle 16, and the covering rate of the fine metal particles 14 to one resin particle was about 10%. The charge control agent was also added to the surface of the metal dispersed resin particle 17.

First, as in the forming process of the resin layer described in the first embodiment, the resin layer 12 of a thickness of 300 nm, a width of 10 μm, and a space of 10 μm was formed on the substrate 11 formed of the polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 20 W for 3 seconds.

By this surface treatment, in the irregularities on the surface of the resin layer 12, the maximum height (Rz) per reference length (1r) of 1 μm was 15 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. However, the deposited film peeled off during plating step, and a favorable plating film, namely, the favorable conductive metal layer 13 was not able to be formed. Peeling off of the plating occurred between the resin layer 12 and the Cu deposition layer, and the fine metal particles 14 remained in the surface with the irregularities of the resin layer 12.

Further, the section of the surface with the irregularities of the resin layer 12 after the conductive metal layer 13 peeled off was observed by the SEM (Scanning Electron Microscope). The result showed that the number (N) of fine metal particles 14, which existed in the region in the rectangular shape enclosed by the sides of a length of 1 μm in the direction parallel with the surface of the substrate 11 and the sides of a length of 300 nm in the direction perpendicular to the surface of the substrate 11 and including the surface of the resin layer 12, and were exposed from the surface with the microscopic irregularities of the resin layer 12, was 10 in the average value in 10 spots. Here, the fine metal particles 14 which were only partially included in the specified rectangular region were also counted in the number.

### COMPARATIVE EXAMPLE 2

In Comparative Example 2, as a liquid toner, the same liquid toner as in Comparative Example 1 was used. First, as in the forming process of the resin layer described in the first embodiment, the resin layer 12 of a thickness of 600 nm, a width of 20 μm, and a space of 20 μm was formed on the substrate 11 formed of a polyimide resin by using the above described liquid toner by the pattern forming apparatus 100.

Next, as shown in FIG. 3, the substrate 11 on which the resin layer 12 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 60 seconds.

By this surface treatment, in the irregularities on the surface of the resin layer 12, the maximum height (Rz) per reference length (1r) of 1 μm was 600 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. However, the deposited film peeled off during the plating step, and a favorable plating film, namely, the favorable conductive metal layer 13 was not able to be formed. Peeling off of the plating occurred between the resin layer 12 and the Cu deposited film, and a number of fine metal particles 14 were exposed to the surface with the irregularities of the resin layer 12.

Further, the reaction was stopped at the extremely early stage of the plating deposition reaction, and the section of the interface of the resin layer 12 and the conductive metal layer 13 was observed by the SEM (Scanning Electron Microscope). The result showed that the number (N) of fine metal particles 14, which existed in the region in the rectangular shape enclosed by the sides of a length of 1 μm in the direction parallel with the surface of the substrate 11 and the sides of a length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, was 200 in the average value in 10 spots. Here, the fine metal particles 14 which were only partially included in the specified rectangular region were also counted in the number. In the observation by the SEM, the resin component was hardly observed. This shows that in the resin layer 12, most of the resin components for firmly bonding the fine metal particles 14 to each other or bonding the fine metal particles 14 and the substrate 11 were removed, and the plating film peeled off with the deposition of plating.

(Summary based on Example 1 to Example 7, and Comparative Examples 1 and 2)

From the results in the above described Example 1 to Example 7, and Comparative Examples 1 and 2, it has been found out that in the case of the wet type development, when the wavelength (λc) at the boundary of the roughness component and the waviness component is 1 μm, the maximum height (Rz) per reference length (1r) of 1 μm is preferably in the range of 20 nm to 500 nm. It has been found out that more preferable range of the maximum height (Rz) per reference length (1r) of 1 μm is 150 nm to 500 nm by which high adhesion strength is obtained, though it depends on the particle size of the fine metal particle 14 and the film thickness of the resin layer 12 to be formed.

It has been found out that the number (N) of the fine metal particles 14, which existed in the region in the rectangular shape enclosed by the sides of a length of 1 μm in the direction parallel with the surface of the substrate 11 and the sides of the length of 300 nm in the direction perpendicular to the surface of the substrate 11 and including the surface of the resin layer 12, were exposed from the surface with the microscopic irregularities of the resin layer 12, and were at least partially in contact with the conductive metal layer 13, is preferably in the range of 20 to 500. It has been found out that the especially preferable range of the number (N) is 80 to 280 by which high adhesion strength can be obtained, though it depends on the particle size of the fine metal particle 14 and the film thickness of the resin layer 12 to be formed.

Next, the conductor patterns formed by the dry development will be shown in Examples 8 to 12, and Comparative Examples 3 and 4. The construction of the substrate which is used as the sample substrate is the same as the construction of the circuit board shown in FIG. 6, and therefore, it will be described with reference to FIG. 6. The composition of the metal dispersed resin particles contained in the liquid toner used here is the same as the composition of the metal dispersed resin particle shown in FIG. 10, and therefore, it will be described with reference to FIG. 10.

### EXAMPLE 8

In Example 8, the metal dispersed resin particle 57 which is a powder toner is the one in which the fine metal particles 54 composed of Ag particles of an average particle size of 5 nm were caused to adhere to the surface of the polyester resin particle 56 which was the thermoplastic resin of an average particle size of 4 μm. The rate of content of the fine metal particles 54 was set at 1.6 weight % with respect to the weight of the resin particles 56, and the covering rate of the fine metal particles 14 to one resin particle was about 80%. The charge control agent was also added to the surface of the metal dispersed resin particle 57.

First, as in the forming process of the resin layer described in the second embodiment, the resin layer 52 of a thickness of 4 μm, a width of 80 μm, and a space of 80 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 20 W for 5 seconds.

By this surface treatment, in the irregularities on the surface of the resin layer 52, the maximum height (Rz) per reference length (1r) of 4 μm was 20 nm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the conveyor means 250, and was immersed in the Cu electroless plating bath. Then, the conductive metal layer 53 that was the electroless plating layer was formed on the resin layer 52. Here, the thickness of the conductor pattern 58 composed of the resin layer 52 and the conductive metal layer 53 was 20 μm.

Annealing treatment for two hours at 180° was applied to the conductor pattern 58 formed as described above. The volume resistivity of the conductor pattern 58 after the annealing treatment was about 1.75×10⁻⁶ Ω·cm.

The degree of adhesion of the conductive metal layer 53 to the resin layer 52 was measured by the Instron type tension testing machine. As s result, the tensile strength was 180 MPa.

Further, the section of the interface of the resin layer 52 and the conductive metal layer 53 was observed by the SEM (Scanning Electron Microscope). As shown in FIG. 7, the result showed that the conductive metal layer 53, which was the plating film, was also formed in the recessed portions in the state in which it substantially followed the microscopic irregularities on the surface of the resin layer 12. The result also showed that the fine metal particles 54 exposed from the surface with the microscopic irregularities of the resin layer 12 were in contact with the conductive metal layer 53. The number (N) of the fine metal particles 54, which existed in the region in the rectangular shape enclosed by the sides of a length of 1 μm in the direction parallel with the surface of the substrate 51 and the sides of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, was 120 in the average value in 10 spots. Here, the fine metal particles 54 which were only partially included in the specified rectangular region were also counted in the number.

The thickness (D1) of the resin layer 52 was 4 μm, the thickness (D2) of the conductive metal layer 53 was 16 μm, and the ratio of D2 and D1 (D2/D1) was 4.

Here, the dispersing amount of the fine Ag particles in the metal dispersed resin particle 57 was increased, and the thing in which the number (N) of the fine metal particles 54, which existed in the region in the rectangular shape enclosed by the sides of a length of 1 μm in the direction parallel with the surface of the substrate 51 and the sides of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, exceeded 500 (600) in the average value in the ten spots was made by way of experiment, and thereby, formation of the conductor pattern 58 was tried. However, under this condition, the electrification characteristics were not stabilized, development characteristics became bad, and the fine pattern of the resin layer 52 was not able to be formed.

(Example of Direct Transfer of Dry Type)

As described above, the two-stage transfer method in which the toner image is transferred by applying the electric field between the photoreceptor and the intermediate transfer belt (or roller), and after the toner image is melted, it is transferred onto the substrate is described, but when the line width and the space are relatively large, the inhibition factor of miniatuarization due to scattering of toner particles by electric field transfer is reduced, and therefore, a direct transfer method for transferring by applying an electric field between the photoreceptor and the backup roller without using the intermediate transfer roller may be adopted. In this case, a hollow metal roller is used as the backup roller, and the substrate is inserted between the backup roller and the photoreceptor with an electric field applied between the backup roller and the photoreceptor, and thereby, the toner image is directly transferred to the substrate. After transferred to the substrate, the toner image may be heated as necessary, and thereby, fixation is enhanced.

### EXAMPLE 9

In Example 9, as the metal dispersed resin particle 57 which was a powder toner, the metal dispersed resin particle 57 which was the same as that in Example 8 was used. First, as in the forming process of the resin layer described in the second embodiment, the resin layer 52 of a thickness of 4 μm, a width of 80 μm, and a space of 80 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 30 seconds.

By this surface treatment, in the irregularities on the surface of the resin layer 52, the maximum height (Rz) per reference length (1r) of 4 μm was 400 nm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the carrier means 250, and was immersed in the Cu electroless plating bath. Then, the conductive metal layer 53 that was the electroless plating layer was formed on the resin layer 52. Here, the thickness of the conductor pattern 58 composed of the resin layer 52 and the conductive metal layer 53 was 20 μm.

Annealing treatment for two hours at 180° was applied to the conductor pattern 58 formed as described above. The volume resistivity of the conductor pattern 58 after the annealing treatment was about 1.75×10⁻⁶ Ω·cm.

The degree of adhesion of the conductive metal layer 53 to the resin layer 52 was measured by the Instron type tension testing machine. As a result, the tensile strength was 200 MPa.

Further, the section of the interface of the resin layer 52 and the conductive metal layer 53 was observed by the SEM (Scanning Electron Microscope). As shown in FIG. 7, the result showed that the conductive metal layer 53, which was the plating film, was also formed in the recessed portions in the state in which it substantially followed the microscopic irregularities on the surface of the resin layer 52. The result also showed that the fine metal particles 54 exposed from the surface with the microscopic irregularities of the resin layer 52 were in contact with the conductive metal layer 53. The number (N) of the fine metal particles 54, which existed in the region in the rectangular shape enclosed by the sides of a length of 1 μm in the direction parallel with the surface of the substrate 51 and the sides of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, was 500 in the average value in 10 spots. Here, the fine metal particles 54 which were only partially included in the specified rectangular region were also counted in the number.

The thickness (D1) of the resin layer 52 was 4 nm, the thickness (D2) of the conductive metal layer 53 was 16 μm, and the ratio of D2 and D1 (D2/D1) was 4.

### EXAMPLE 10

In Example 10, the metal dispersed resin particle 57 which was a powder toner was the one in which the fine metal particles 54 composed of fine Ag particles of an average particle size of 50 nm were caused to adhere to the surface of the epoxy resin particle 56 in a half-cured state, which was the thermosetting resin of an average particle size of 4 μm. The rate of content of the fine metal particles 54 was set at 20 weight % with respect to the weight of the resin particles 56, and the covering rate of the fine metal particles 14 to one resin particle was about 48%. The charge control agent was also added to the surface of the metal dispersed resin particle 57.

First, as in the forming process of the resin layer described in the second embodiment, the resin layer 52 of a thickness of 4 μm, a width of 80 μm, and a space of 80 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 30 seconds.

By this surface treatment, in the irregularities on the surface of the resin layer 52, the maximum height (Rz) per reference length (1r) of 4 μm was 400 nm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the carrier means 250, and was immersed in the Cu electroless plating bath. Then, the conductive metal layer 53, that was the electroless plating layer was formed on the resin layer 52. Here, the thickness of the conductor pattern 58 composed of the resin layer 52 and the conductive metal layer 53 was 20 μm.

Annealing treatment for two hours at 250° was applied to the conductor pattern 58 formed as described above. The volume resistivity of the conductor pattern 58 after the annealing treatment was about 1.75×10⁻⁶ Ω·cm.

The degree of adhesion of the conductive metal layer 53 to the resin layer 52 was measured by the Instron type tension testing machine. As a result, the tensile strength was 230 MPa.

Further, the section of the interface of the resin layer 52 and the conductive metal layer 53 was observed by the SEM (Scanning Electron Microscope). As shown in FIG. 7, the result showed that the conductive metal layer 53, which was the plating film, was also formed in the recessed portions in the state in which it substantially followed the microscopic irregularities on the surface of the resin layer 12. The result also showed that the fine metal particles 54 exposed from the surface with the microscopic irregularities of the resin layer 12 were in contact with the conductive metal layer 53. The number (N) of the fine metal particles 54, which existed in the rectangular region enclosed by the sides of a length of 1 μm in the direction parallel with the surface of the substrate 51 and the side of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, was 60 in the average value in 10 spots. Here, the fine metal particles 54 which were only partially included in the specified rectangular region were also counted in the number.

The thickness (D1) of the resin layer 52 was 4 μm, the thickness (D2) of the conductive metal layer 53 was 16 μm, and the ratio of D2 and D1 (D2/D1) was 4.

### EXAMPLE 11

In Example 11, the metal dispersed resin particle 57 which was a powder toner was the one in which the fine metal particles 54 composed of fine Ag particles of an average particle size of 200 nm are caused to adhere to the surface of the epoxy resin particle 56 which is a thermosetting resin of an average particle size of 6 μm. The rate of content of the fine metal particles 54 was set at 30 weight % with respect to the weight of the resin particles 56, and the covering rate of the fine metal particles 14 to one resin particle was about 26%. The charge control agent was also added to the surface of the metal dispersed resin particle 57.

First, as in the forming process of the resin layer described in the second embodiment, the resin layer 52 of a thickness of 10 μm, a width of 80 μm, and a space of 120 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 80 seconds.

By this surface treatment, in the irregularities on the surface of the resin layer 52, the maximum height (Rz) per reference length (1 r) of 4 μm was 1 μm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the carrier means 250, and was immersed in the Cu electroless plating bath. Then, the conductive metal layer 53 that was the electroless plating layer was formed on the resin layer 52. Here, the thickness of the conductor pattern 58 composed of the resin layer 52 and the conductive metal layer 53 was 30 μm.

Annealing treatment for two hours at 250° was applied to the conductor pattern 58 formed as described above. The volume resistivity of the conductor pattern 58 after the annealing treatment was about 1.75×10⁻⁶ Ω·cm.

The degree of adhesion of the conductive metal layer 53 to the resin layer 52 was measured by the Instron type tension testing machine. As a result, the tensile strength was 250 MPa.

Further, the section of the interface of the resin layer 52 and the conductive metal layer 53 was observed by the SEM (Scanning Electron Microscope). As shown in FIG. 7, the result showed that the conductive metal layer 53, which was the plating film, was also formed in the recessed portions in the state in which it substantially followed the microscopic irregularities on the surface of the resin layer 52. The result also showed that the fine metal particles 54 exposed from the surface with the microscopic irregularities of the resin layer 52 were in contact with the conductive metal layer 53. The number (N) of fine metal particles 54, which existed in the region in the rectangular shape enclosed by the sides of a length of 1 μm in the direction parallel with the surface of the substrate 51 and the sides of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, was 18 in the average value in 10 spots. Here, the fine metal particles 54 which were only partially included in the specified rectangular region were also counted in the number.

The thickness (D1) of the resin layer 52 was 10 μm, the thickness (D2) of the conductive metal layer 53 was 20 μm, and the ratio of D2 and D1 (D2/D1) was 2.

### EXAMPLE 12

In Example 12, the metal dispersed resin particle 57 which was a powder toner is the one in which the fine metal particles 54 composed of fine Ag particles of an average particle size of 500 nm are caused to adhere to the surface of the epoxy resin particle 56 which was the thermosetting resin of an average particle size of 8 μm. The rate of content of the fine metal particles 54 was set at 30 weight % with respect to the weight of the resin particles 56, and the covering rate of the fine metal particles 54 to one resin particle was about 14%. The charge control agent was also added to the surface of the metal dispersed resin particle 57.

First, as in the forming process of the resin layer described in the second embodiment, the resin layer 52 of a thickness of 15 μm, a width of 150 μm, and a space of 150 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 500 W for 100 seconds.

By this surface treatment, in the irregularities on the surface of the resin layer 52, the maximum height (Rz) per reference length (1r) of 4 μm was 1 μm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the carrier means 250, and was immersed in the Cu electroless plating bath. Then, the conductive metal layer 53 that was the electroless plating layer was formed on the resin layer 52. Here, the thickness of the conductor pattern 58 composed of the resin layer 52 and the conductive metal layer 53 was 30 μm.

Annealing treatment for two hours at 250° was applied to the conductor pattern 58 formed as described above. The volume resistivity of the conductor pattern 58 after the annealing treatment was about 1.75×10⁻⁶ Ω·cm.

The degree of adhesion of the conductive metal layer 53 to the resin layer 52 was measured by the Instron type tension testing machine. As a result, the tensile strength was 150 MPa.

Further, the section of the interface of the resin layer 52 and the conductive metal layer 53 was observed by the SEM (Scanning Electron Microscope). As shown in FIG. 7, the result showed that the conductive metal layer 53, which was the plating film, was also formed in the recessed portions in the state in which it substantially followed the microscopic irregularities on the surface of the resin layer 52. The result also showed that the fine metal particles 54 exposed from the surface with the microscopic irregularities of the resin layer 52 were in contact with the conductive metal layer 53. The number (N) of the fine metal particles 54, which existed in the region in the rectangular shape enclosed by the sides of a length of 1 μm in the direction parallel with the surface of the substrate 51 and the sides of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, was 3 in the average value in 10 spots. Here, the fine metal particles 54 which were only partially included in the specified rectangular region were also counted in the number.

The thickness (D1) of the resin layer 52 was 15 μm, the thickness (D2) of the conductive metal layer 53 was 15 μm, and the ratio of D2 and D1 (D2/D1) was 1.

### COMPARATIVE EXAMPLE 3

In Comparative Example 3, the metal dispersed resin particle 57 which was a powder toner was the one in which the fine metal particles 54 composed of fine Ag particles of an average particle size of 200 nm were caused to adhere to the surface of the polyester resin particle 56 which was the thermoplastic resin of an average particle size of 4 μm. The rate of content of the fine metal particles 54 was set at 30 weight % with respect to the weight of the resin particles 56, and the covering rate of the fine metal particles 54 to one resin particle was about 18%. The charge control agent was also added to the surface of the metal dispersed resin particle 57.

First, as in the forming process of the resin layer described in the second embodiment, the resin layer 52 of a thickness of 4 μm, a width of 80 μm, and a space of 80 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 20 W for 3 seconds.

By this surface treatment, in the irregularities on the surface of the resin layer 52, the maximum height (Rz) per reference length (1r) of 4 μm was 18 nm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the carrier means 250, and was immersed in the Cu electroless plating bath. However, the deposition film peeled off during the plating step, and a favorable plating film, namely, the favorable conductive metal layer 53 was not able to be formed. Peeling off of the plating occurred between the resin layer 52 and the Cu deposition layer, and the fine metal particles 54 remained in the surface with irregularities of the resin layer 12.

Further, the section of the surface with irregularities of the resin layer 12 after the conductive metal layer 53 peeled off was observed by the SEM (Scanning Electron Microscope). The result showed that the number (N) of fine metal particles 54, which existed in the region in the rectangular shape enclosed by the sides of a length of 1 μm in the direction parallel to the surface of the substrate 51 and the sides of a length of 300 nm in the direction perpendicular to the surface of the substrate 51 and including the surface of the resin layer 52, and were exposed from the surface with microscopic irregularities of the resin layer 52, was 3 in the average value in 10 spots. Here, the fine metal particles 54 which were only partially included in the specified rectangular region were also counted in the number. It has been found out that since the number (N) was three as described above, and the absolute value of the number of fine metal particles to be the plating nuclei is small, the copper plating in the state raised from the resin layer 52 becomes thick as deposition of the copper plating film advanced, and when the copper plating film deposited to a certain film thickness, the copper plating film peeled off.

### COMPARATIVE EXAMPLE 4

In Comparative Example 4, the metal dispersed resin particle 57 which was the powder toner was the one in which the fine metal particles 54 composed of fine Ag particles of an average particle size of 5 nm are caused to adhere to the surface of the polyester resin particle 56 which was the thermoplastic resin of an average particle size of 4 μm. The rate of content of the fine metal particles 54 was set at 1.6 weight % with respect to the weight of the resin particles 56, and the covering rate of the fine metal particles 54 to one resin particle was about 80%. The charge control agent was also added to the surface of the metal dispersed resin particle 57.

First, as in the forming process of the resin layer described in the second embodiment, the resin layer 52 of a thickness of 4 μm, a width of 80 μm, and a space of 80 μm was formed on the substrate 51 formed of the polyimide resin by using the above described metal dispersed resin particles 57 by the pattern forming apparatus 300.

Next, as shown in FIG. 8, the substrate 51 on which the resin layer 52 was formed was conveyed to the surface treatment apparatus 150 by the carrier means 250, and was inserted into the vacuum tank which was decompressed to 10⁻⁴ Pa. Then, the mixture gas of an oxygen gas and a fluorine gas was introduced into the vacuum tank to generate plasma, and the surface treatment by plasma was performed with the power of 50 W for 120 seconds.

By this surface treatment, in the irregularities on the surface of the resin layer 52, the maximum height (Rz) per reference length (1r) of 4 μm was 1.8 μm when the wavelength (λc) at the boundary of the roughness component and the waviness component was 4 μm in the roughness curve of the section of the resin layer 52 (defined in JIS B 0601 (2001)).

Next, as shown in FIG. 8, the substrate 51 with the surface treatment applied to the resin layer 52 was conveyed to the electroless plating apparatus 200 by the carrier means 250, and was immersed in the Cu electroless plating bath. However, during the plating step, the fine metal particles 54 peeled off and were suspended in the electroless plating bath, and the favorable plating film, namely, the favorable conductive metal layer 53 was not able to be formed. Peeling off of the plating occurred between the resin layer 52 and the Cu deposition film, and the fine metal particles 54 were exposed to the surface with irregularities of the resin layer 12.

Further, the section of the surface with irregularities of the resin layer 52 after the conductive metal layer 53 peeled off was observed by the SEM (Scanning Electron Microscope). The result showed that the number (N) of the fine metal particles 54, which existed in the region of the rectangular shape enclosed by the sides of a length of 1 μm in the direction parallel with the surface of the substrate 51 and the side of a length of 300 nm in the direction perpendicular to the surface of the substrate 51 and including the surface of the resin layer 52, and were exposed from the surface with the microscopic irregularities of the resin layer 52, was eight in the average value in 10 spots. Here, the fine metal particles 54 which were only partially included in the specified rectangular region were also counted in the number. Under the conditions, the resin component was removed even in the inside of the metal dispersed resin particle 57 and large irregularities were formed by plasma treatment. Substantial parts of the surface layers of the metal dispersed resin particles 57 were removed, most of the resin inside was exposed, the fine metal particles 54 held on the surface of the metal dispersed resin particles 57 lost resin at the adhering portions on the surfaces of the metal dispersed resin particles 57, and were in the state where they only weakly adhere onto the exposed resin surfaces. Thereby, it has been found out that when they were immersed in the plating bath, they easily peeled off the resin surface and favorable plating was not deposited.

(Summary Based on Example 8 to Example 12, and Comparative Examples 3 and 4)

From the results in the above described Example 8 to Example 12, and Comparative Examples 3 and 4, it has been found out that in the case of the dry type development, when the wavelength (λc) at the boundary of the roughness component and the waviness component is 4 μm, the maximum height (Rz) per reference length (1r) of 4 μm is preferably in the range of 20 nm to 1 μm. It has been found out that more preferable range of the maximum height (Rz) per reference length (1r) of 4 μm is 400 nm to 1 μm by which high adhesion strength can be provided, though it depends on the particle size of the fine metal particle 54 and the film thickness of the resin layer 52 to be formed.

It has been found out that the number (N) of fine metal particles 54, which existed in the region in the rectangular shape enclosed by the sides of a length of 1 μm in the direction parallel with the surface of the substrate 51 and the sides of a length of 300 nm in the direction perpendicular to the surface of the substrate 51 and including the surface of the resin layer 52, were exposed from the surface with the microscopic irregularities of the resin layer 52, and were at least partially in contact with the conductive metal layer 53, is preferably in the range of 3 to 500. It has been found out that the especially preferable range of the number (N) is 18 to 60 by which high adhesion strength can be provided, though it depends on the particle size of the fine metal particle 54 and the film thickness of the resin layer 52 to be formed.

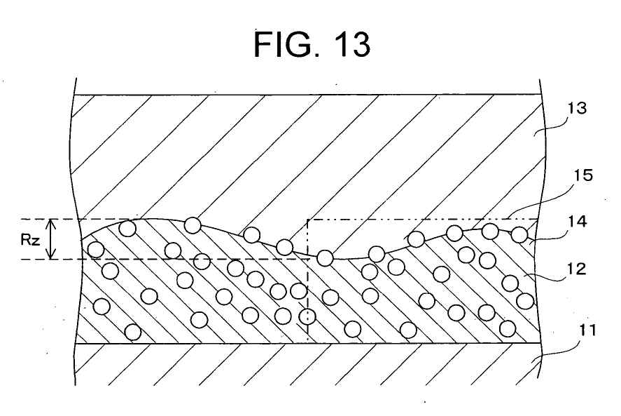

Next, the surface roughness of the resin layer and formation of the conductive metal layer which is the plating deposition layer in the case where the surface treatment of the resin layer is performed by chemical solutions or mechanical polishing will be described in Comparative Examples 5 and 6, and excellence of performing plasma treatment for the surface of the resin layer by the surface treatment apparatus 150 will be described. FIG. 13 schematically shows the section of the resin layer 12 when surface roughening by the chemical solution is performed under magnification.

### COMPARATIVE EXAMPLE 5

In Comparative Example 5, surface roughening by the chemical solution was performed by using the resin layer 12 of a thickness of 500 nm, a width of 20 μm, and a space of 20 μm which was formed on the substrate 11 in the above described Example 1. Specifically, the substrate 11 on which the resin layer 12 was formed was immersed in the water solution with potassium permanganate as a main constituent for five minutes, and thereafter, neutralization process was performed.

By this surface treatment, in the irregularities on the surface of the resin layer 12, the maximum height (Rz) per reference length (1r) of 1 μm was 15 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. However, during the plating step, the deposited film peeled off, and a favorable plating film, namely, the favorable conductive metal layer 13 was not able to be formed.

Further, the section of the surface with irregularities of the resin layer 12 after the conductive metal layer 13 peeled off was observed by the SEM (Scanning Electron Microscope). The result showed that the number (N) of the fine metal particles 14, which existed in the region in the rectangular shape enclosed by the sides of a length of 1 μm in the direction parallel with the surface of the substrate 11 and the side of a length of 300 nm in the direction perpendicular to the surface of the substrate 11 and including the surface of the resin layer 12, and were exposed from the surface with the microscopic irregularities of the resin layer 12, was 18 in the average value in 10 spots. Here, the fine metal particles 14 which were only partially included in the specified rectangular region were also counted in the number.

As shown in FIG. 13, in the surface roughening by the treatment of the chemical solution, the surface of the resin layer 12 was relatively flat as compared with the case of the plasma treatment in the above described Example 1, the maximum height (Rz) per reference length (1r) of 1 μm was small, and the number of fine metal particles 14 exposed from the surface with the irregularities was small. Thereby, it has been found out that on the occasion of the plating step, strong adhesion cannot be obtained, and the plating deposition film peels off halfway.

### COMPARATIVE EXAMPLE 6

In Comparative Example 6, surface roughening by mechanical polishing was performed by using the resin layer 12 of a thickness of 500 nm, a width of 20 μm, and a space of 20 μm which was formed on the substrate 11 in the above described Example 1. Specifically, sandblasting by using fine spherical ceramic powder of 3 μm or less was applied to the surface of the resin layer 12.

By this surface treatment, in the irregularities on the surface of the resin layer 12, the maximum height (Rz) per reference length (1r) of 1 μm was 2 nm when the wavelength (λc) at the boundary of the roughness component and the waviness component was 1 μm in the roughness curve of the section of the resin layer 12 (defined in JIS B 0601 (2001)).

Next, as shown in FIG. 3, the substrate 11 with the surface treatment applied to the resin layer 12 was conveyed to the electroless plating apparatus 200 by the carrier means 250, and was immersed in the Cu electroless plating bath. However, during the plating step, the deposition film peeled off, and a favorable plating film, namely, the favorable conductive metal layer 13 was not able to be formed.

Further, the section of the surface with irregularities of the resin layer 12 after the conductive metal layer 13 peeled off was observed by the SEM (Scanning Electron Microscope). The result showed that the number (N) of fine metal particles 14, which existed in the region in the rectangular shape enclosed by the sides of a length of 1 μm in the direction parallel with the surface of the substrate 11 and the sides of a length of 300 nm in the direction perpendicular to the surface of the substrate 11 and including the surface of the resin layer 12, and were exposed from the surface with the microscopic irregularities of the resin layer 12, was five in the average value in 10 spots. Here, the fine metal particles 14 which were only partially included in the specified rectangular region were also counted in the number.

In the surface roughening by the treatment of the mechanical polishing, the surface of the resin layer 12 was extremely flat as compared with the case of the plasma treatment in the above described Example 1, the maximum height (Rz) per reference length (1r) of 1 μm was small, and the number of fine metal particles 14 was extremely small because the fine metal particles 14 exposed to the surface were shaved off at the same time by polishing. Thereby, it has been found out that on the occasion of the plating step, strong adhesion cannot be obtained, and the plating deposition film peels off halfway.

(Summary Based on Comparative Examples 5 and 6)

From the above described Comparative Examples 5 and 6, it has been found out that when the surface treatment of the resin layer 12 is performed by plasma treatment, the maximum height (Rz) per reference length (1r) of 1 μm is larger, and the number of fine metal particles 14 in the surface with irregularities of the resin layer 12 becomes larger than when it is performed by the chemical solution treatment or mechanical polishing. Thereby, it becomes obvious that the conductive metal layer 13 firmly adhering to the resin layer 12 can be formed in the case where the surface treatment is performed by plasma treatment, and therefore, it is more preferable than the case where the surface treatment of the resin layer is performed by chemical solution treatment or mechanical polishing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A circuit board, comprising:
a substrate;
a resin layer selectively formed on said substrate and containing fine metal particles; and
a conductive metal layer formed on said resin layer, in contact with said fine metal particles which are exposed from said resin layer,
wherein in irregularities of said resin layer in an interface of said resin layer and said conductive metal layer, a maximum height (Rz) per reference length (1r=λc) is 20 nm≦Rz≦500 nm when a wavelength at a boundary of a roughness component and a waviness component is set as λc in a roughness curve of a section of said resin layer.

2. The circuit board according to claim 1,
wherein in the section of said resin layer, a number (N) of said fine metal particles, which exist in a region in a rectangular shape enclosed by sides of a length of 1 μm in a direction parallel with a surface of said substrate and by sides of a length of 300 nm in a direction perpendicular to the surface of said substrate, and are at least partially in contact with said conductive metal layer, is 20≦N≦500.

3. The circuit board according to claim 1,
wherein a particle size of said fine metal particle is 5 nm to 100 nm.

4. A circuit board, comprising:
a substrate;
a resin layer selectively formed on said substrate and containing fine metal particles; and
a conductive metal layer formed on said resin layer, in contact with said fine metal particles which are exposed from said resin layer,
wherein in irregularities of said resin layer in an interface of said resin layer and said conductive metal layer, a maximum height (Rz) per reference length (1r=λc) is 20 nm≦Rz≦1 μm when a wavelength at a boundary of a roughness component and a waviness component is set as λc in a roughness curve of a section of said resin layer.

5. The circuit board according to claim 4,
wherein in the section of said resin layer, a number (N) of said fine metal particles, which exist in a region in a rectangular shape enclosed by sides of a length of 1 μm in a direction parallel with a surface of said substrate and by sides of a length of 300 nm in a direction perpendicular to the surface of said substrate, and are at least partially in contact with said conductive metal layer, is 3≦N≦500.

6. The circuit board according to claim 4,
wherein a particle size of said fine metal particle is 5 nm to 500 nm.

7. A manufacturing method of a circuit board, comprising:
forming an electrostatic latent image of a predetermined pattern on a photoreceptor;
causing an electric insulating solvent, in which resin particles having fine metal particles are dispersed, to adhere onto the photoreceptor on which the electrostatic latent image is formed to form a visible image;
drying the solvent adhering onto the photoreceptor;
forming a resin layer on a base material by transferring the dried visible image onto the base material;
performing surface treatment for a surface of the resin layer formed on the base material by plasma to form a surface with irregularities on the surface; and
forming a conductive metal layer in contact with the fine metal particles exposed from the resin layer, on the resin layer subjected to said surface treatment.

8. The manufacturing method according to claim 7,
wherein in said surface treatment, the surface with irregularities of which maximum height (Rz) per reference length (1r=λc) is 20 nm≦Rz≦500 nm when a wavelength at a boundary of a roughness component and a waviness component is set as λc in a roughness curve of a section of said resin layer is formed.

9. The manufacturing method according to claim 7,
wherein in said forming of the resin layer, the dried visible image is transferred onto an intermediate transfer base, and the visible image transferred onto the intermediate transfer base is transferred onto the base material.

10. The manufacturing method according to claim 7,
wherein in a section of the resin layer after said surface treatment, a number (N) of the fine metal particles, which exist in a region in a rectangular shape enclosed by sides of a length of 1 μm in a direction parallel with a surface of the substrate and by sides of a length of 300 nm in a direction perpendicular to the surface of the substrate, and are at least partially exposed to be in contact with the conductive metal layer, is 20≦N≦500.

11. A manufacturing method of a circuit board, comprising:
forming an electrostatic latent image of a predetermined pattern on a photoreceptor;
causing resin particles having fine metal particles to adhere onto the photoreceptor on which the electrostatic latent image is formed to form a visible image;
forming a resin layer on a base material by transferring the resin particles constituting the visible image onto the base material;
performing surface treatment for a surface of the resin layer formed on the base material by plasma to form a surface with irregularities on the surface; and
forming a conductive metal layer in contact with the fine metal particles exposed from the resin layer, on the resin layer subjected to said surface treatment.

12. The manufacturing method according to claim 11,
wherein in said surface treatment, the surface with irregularities of which maximum height (Rz) per reference length (1r=λc) is 20 nm≦Rz≦1 μm when a wavelength at a boundary of a roughness component and a waviness component is set as λc in a roughness curve of a section of the resin layer is formed.

13. The manufacturing method according to claim 11,
wherein in said forming of the resin layer, the resin particles which constitute the visible image are transferred onto an intermediate transfer base by an electric field formed between the photoreceptor and the intermediate transfer base, and the resin particles transferred onto the intermediate transfer base are transferred onto the base material.

14. The manufacturing method according to claim 11,
wherein in a section of the resin layer after said surface treatment, a number (N) of the fine metal particles, which exist in a region in a rectangular shape enclosed by sides of a length of 1 μm in a direction parallel with a surface of the substrate and by sides of a length of 300 nm in a direction perpendicular to the surface of the substrate, and are at least partially exposed to be in contact with the conductive metal layer, is 3≦N≦500.
